(19) United States
(12) Patent Application Publication
(10) Pub. No.: US 2025/0379614 A1
(43) Pub. Date: Dec. 11, 2025

(54) PLATFORM AGNOSTIC VIRTUALIZED DISTRIBUTED ANTENNA SYSTEM DEPLOYMENT

(71) Applicant: OUTDOOR WIRELESS NETWORKS LLC, Claremont, NC (US)

(72) Inventor: Suresh N. Sriram, Bangalore (IN)

(73) Assignee: Outdoor Wireless Networks LLC, Claremont, NC (US)

(21) Appl. No.: 18/879,695

(22) PCT Filed: Jun. 27, 2023
(86) PCT No.: PCT/US2023/069172

§ 371 Date: Dec. 27, 2024

(30) Foreign Application Priority Data
Jun. 28, 2022 (IN) 202241037029

(51) Int. Cl. H04B 7/022; H04L 41/0806; H04L 41/0897

(52) U.S. Cl. CPC H04B 7/022; H04L 41/0806; H04L 41/0897

(57) ABSTRACT

One embodiment is directed to a virtual distributed antenna system (vDAS) that comprises one or more self-configuration entities configured to: determine characteristics of one or more donor base stations: determine available resources that are available to implement the vDAS; determine, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and configure the vDAS to serve the one or more donor base stations in accordance with the scaled configuration by executing the scalable vDAS software on physical server computers in accordance with the scaled configuration. Other embodiments are disclosed.

### CROSS-REFERENCE TO RELATED APPLICATIONS

This application claims the benefit of Indian Provisional Patent Application Serial No. 202241037029, filed on Jun. 28, 2022, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote antenna units” or “radio units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment. Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, combining or summing uplink signals received from multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Custom, physical hardware is typically used to implement the various nodes of a DAS. Also, the various nodes of a DAS are typically coupled to each other using dedicated point-to-point communication links. While these dedicated point-to-point links may be implemented using Ethernet physical layer (PHY) technology (for example, by using Gigabit Ethernet PHY devices and cabling), conventional “shared” switched Ethernet networks are typically not used for communicating among the various nodes of a DAS.

As a result, a traditional DAS is typically expensive to deploy—both in terms of product and installation costs. Moreover, the scalability and upgradeability of a traditional DAS is typically limited, time-consuming, and involves adding or changing hardware and/or communication links.

### SUMMARY

One embodiment is directed to a virtualized distributed antenna system (vDAS) to serve a set of one or more donor base stations. The vDAS comprises a set of one or more physical server computers on which scalable vDAS software is executed. Each of the physical server computers is configured to execute respective virtualization software that creates a respective virtualized environment in which the scalable vDAS software is executed to carry out a respective one or more roles for the vDAS. The vDAS further comprises a plurality of access points (APs). Each of the APs is associated with a respective set of coverage antennas and each of the APs is communicatively coupled to at least one of the set of physical server computers. The vDAS further comprises one or more self-configuration entities configured to: determine characteristics of the one or more donor base stations; determine available resources that are available to implement the vDAS; determine, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and configure the vDAS to serve the one or more donor base stations in accordance with the scaled configuration by executing the scalable vDAS software on each of the physical server computers in accordance with the scaled configuration.

Another embodiment is directed to a method of configuring a virtualized distributed antenna system (vDAS) used to serve a set of one or more donor base stations. The vDAS comprises a set of one or more physical server computers. Each of the physical server computers is configured to execute respective virtualization software that creates a respective virtualized environment in which the scalable vDAS software is executed to carry out a respective one or more roles for the vDAS. The vDAS further comprises a plurality of access points (APs). Each of the APs is associated with a respective set of coverage antennas and each of the APs is communicatively coupled to at least one of the set of physical server computers. The method comprises: determining characteristics of the one or more donor base stations; determining available resources that are available to implement the vDAS; determining, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and configuring the vDAS to serve the one or more donor base stations in accordance with the scaled configuration by executing the scalable vDAS software on each of the physical server computers in accordance with the scaled configuration.

Other embodiments are disclosed.

The details of various embodiments are set forth in the accompanying drawings and the description below. Other features and advantages will become apparent from the description, the drawings, and the claims.

### BRIEF DESCRIPTION OF DRAWINGS

FIGS. 1A-1C are block diagrams illustrating one exemplary embodiment of a virtualized DAS (vDAS).

FIG. 2 is a block diagram illustrating one exemplary embodiment of an access point that can be used in the vDAS of FIGS. 1A-1C.

FIGS. 3A-3D are block diagrams illustrating one exemplary embodiment of vDAS in which at least some of the APs are coupled to one or more vMU serving them via one or more virtual intermediate combining nodes (vICNs).

FIG. 4 is a block diagram illustrating one exemplary embodiment of vDAS in which one or more physical donor RF interfaces are configured to by-pass the associated vMUs.

FIG. 5 is a simplified block diagram illustrating some additional implementation details for the virtual distributed antenna systems shown above.

FIG. 6 comprises a high-level flowchart illustrating one exemplary embodiment of a method of configuring a virtualized distributed antenna system.

Like reference numbers and designations in the various drawings indicate like elements.

### DETAILED DESCRIPTION

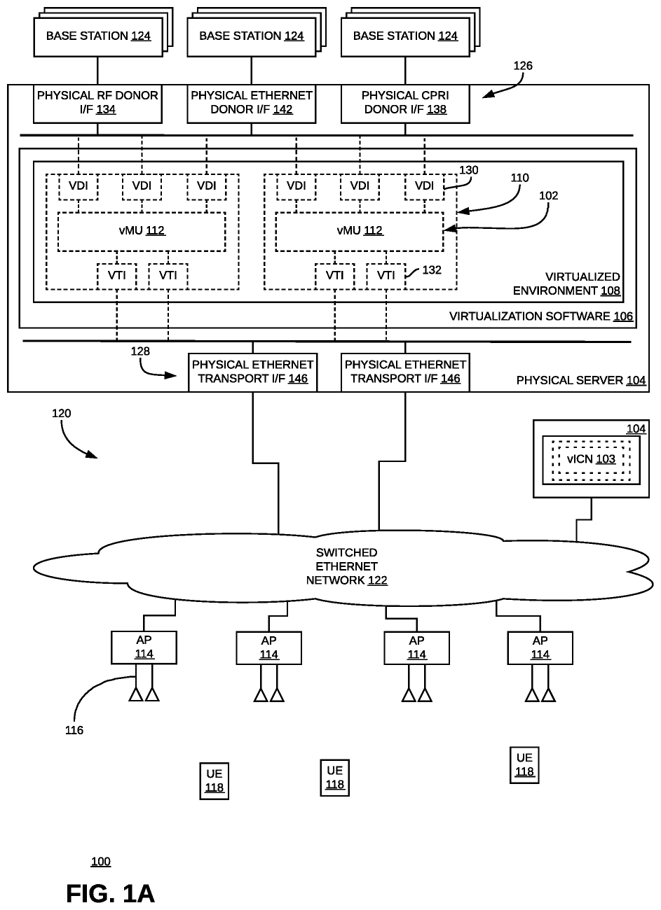

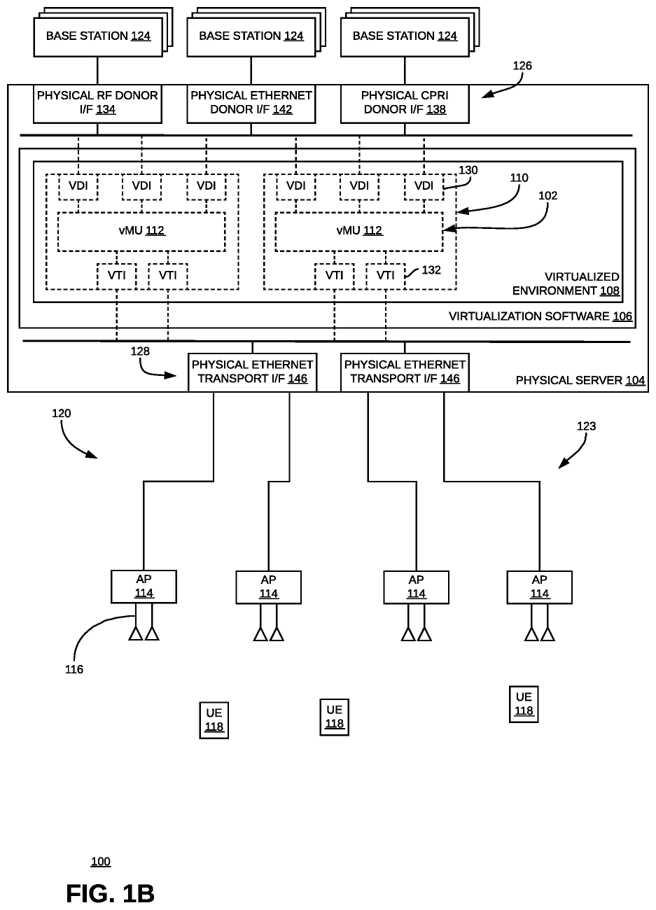

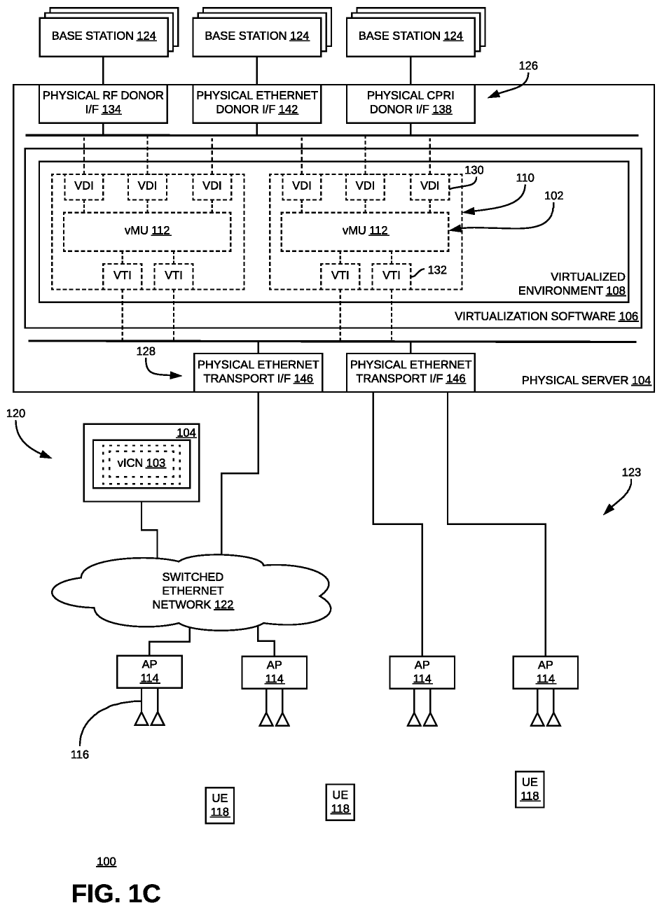

FIGS. 1A-1C are block diagrams illustrating one exemplary embodiment of a virtualized DAS (vDAS) 100. In the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software that is configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 in order to provide a virtualized environment 108 in which one or more one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred here to as “remote antenna units” (RAUs) or “radio units” (RUs)) 114. Each vMU 112 is configured to implement at least some of the functions normally carried out by a physical master unit or CAN in a traditional DAS.

Each of the vMU 112 is implemented as a respective one or more VNFs 102 deployed on one or more of the physical servers 104. Each of the APs 114 is implemented as a physical network function (PNF) and is deployed in or near a physical location where coverage is to be provided.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Although only two coverage antennas 116 are shown in FIGS. 1A-1C for ease of illustration, it is to be understood that other numbers of coverage antennas 116 can be used. Each of the APs 114 is communicatively coupled to the respective one or more vMU 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it using at least some shared communication links.

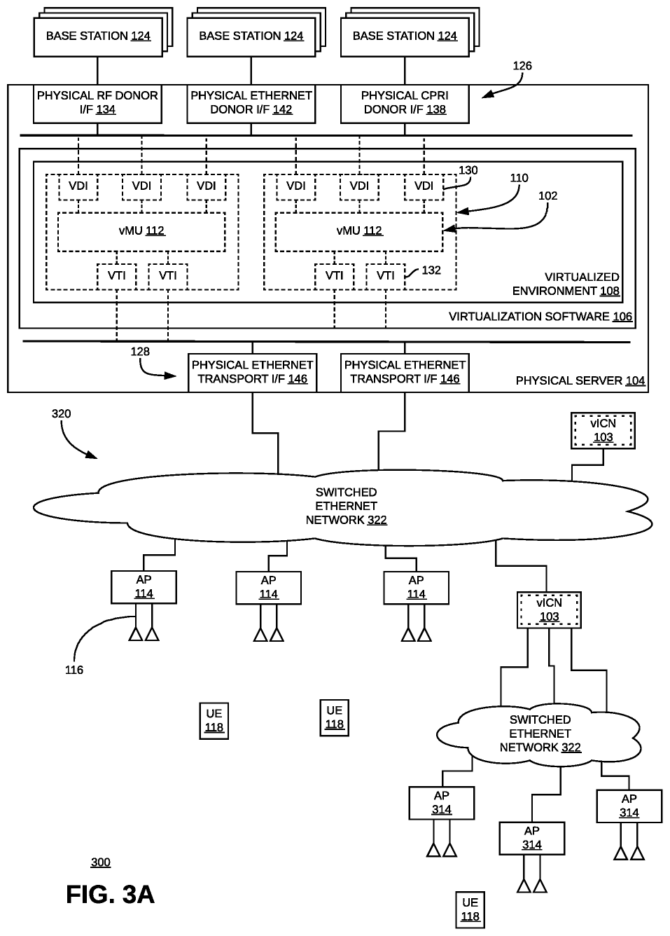

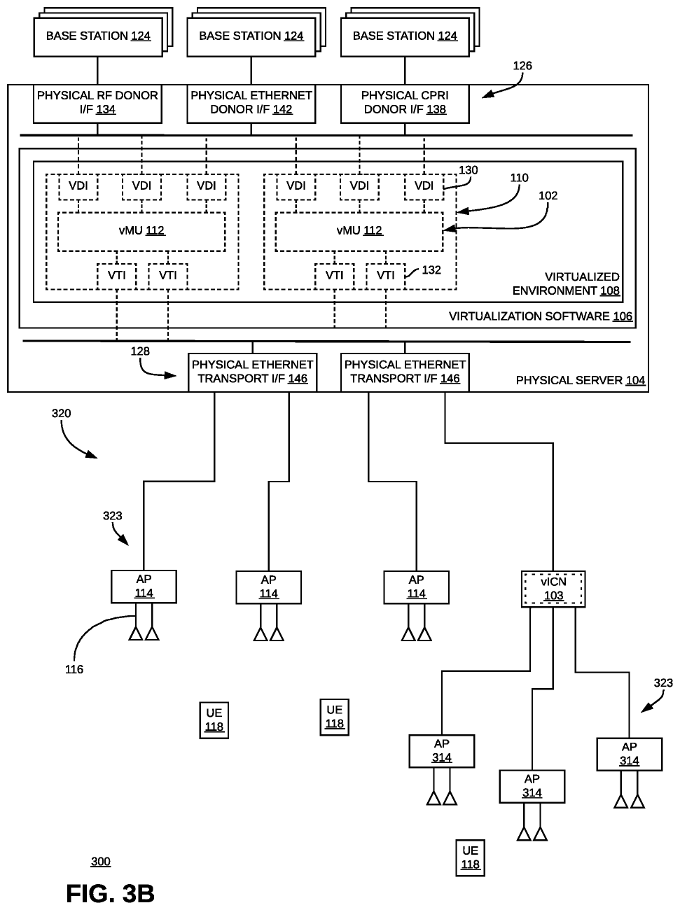

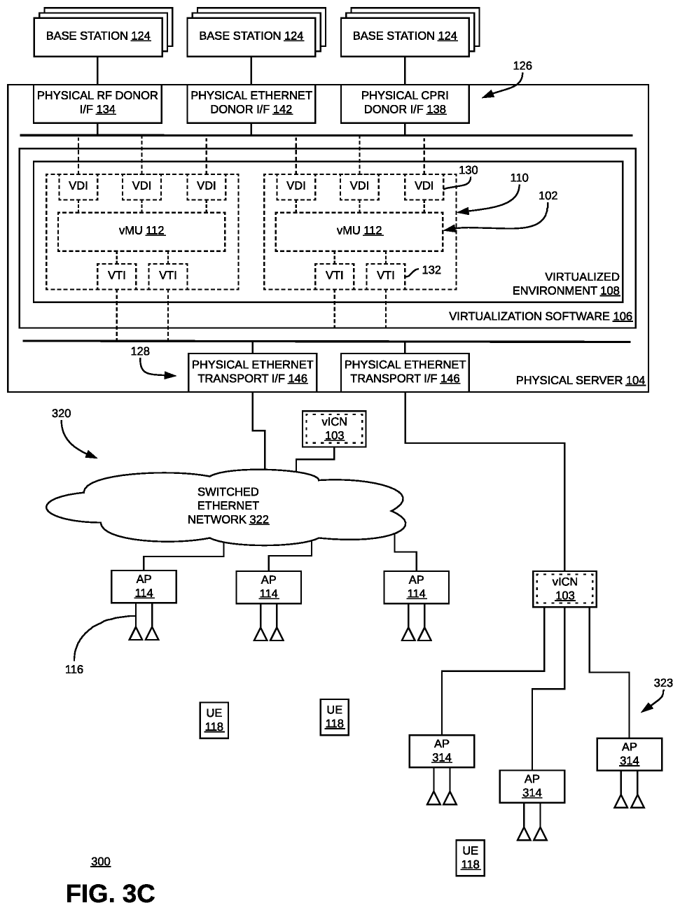

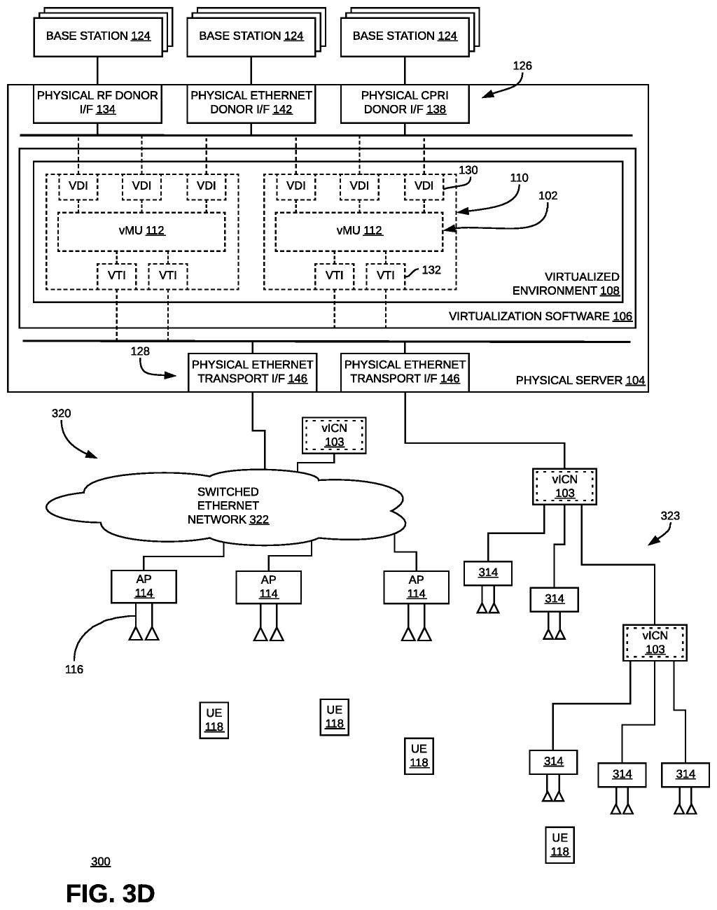

In the example shown in FIG. 1B, the fronthaul network 120 is implemented using only point-to-point Ethernet links 123, where each AP 114 is coupled to each serving vMU 112 serving it via a respective one or more point-to-point Ethernet links 123. In the example shown in FIG. 1C, the fronthaul network 120 is implemented using a combination of a switched Ethernet network 122 and point-to-point Ethernet links 123, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 123. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124 in order to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an O-RAN fronthaul interface) and different functional splits can be supported (including, for example, functional split 8, functional split 7-2, and functional split 6). The O-RAN Alliance publishes various specifications for implementing RANs in an open manner. (“O-RAN” is an acronym that also stands for “Open RAN,” but in this description references to “O-RAN” should be understood to be referring to the O-RAN Alliance and/or entities or interfaces implemented in accordance with one or more specifications published by the O-RAN Alliance.)

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for use in such deployments because vMUs 112 can be easily instantiated in order to support additional wireless service operators. This is the case even if an additional physical server computer 104 is needed in order to instantiate a new vMU 112 because such physical server computers 104 are either already available in such deployments or can be easily added at a low cost (for example, because of the COTS nature of such hardware). Other vDAS entities implemented in virtualized manner (for example, ICNs) can also be easily instantiated or removed as needed based on demand.

In the example shown in FIGS. 1A-1C, the physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114 and ICNs). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes or is in communication with separate physical donor and transport interfaces 126 and 128; however, it is to be understood that in other embodiments a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

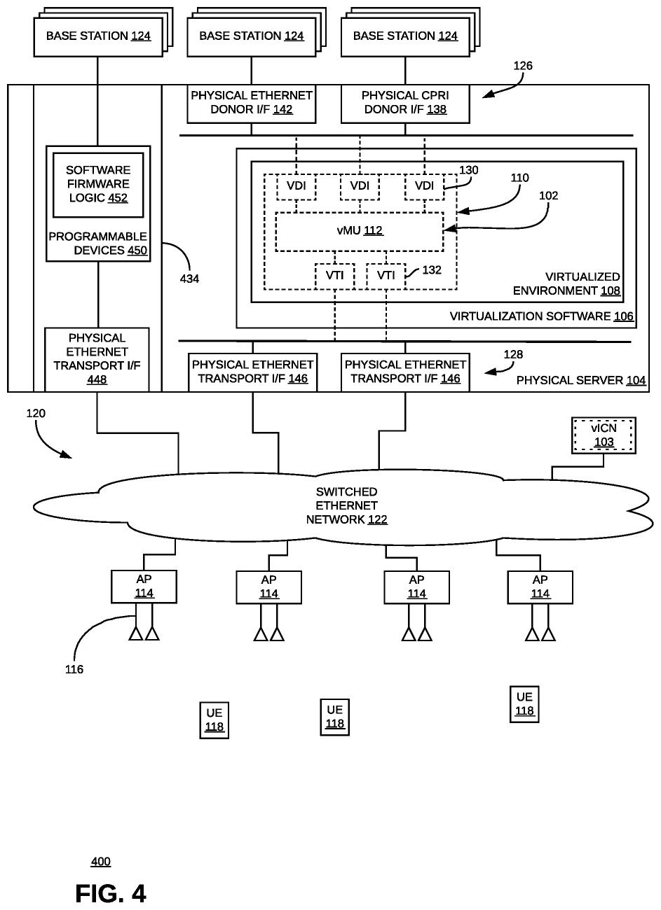

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by implementing the physical RF donor interface 134 as a card inserted in the physical server computer 104 and communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain user-plane data, and output it to a vMU 112 executing on the same server computer 104 in which that RF donor interface 134 is deployed. Also, each physical RF donor interface 134 is configured, for each base station 124 coupled to it, to receive combined uplink time-domain user-plane data from the vMU 112 for that base station 124, convert the received combined uplink time-domain user-plane data to uplink analog RF signals, and output them to the base station 124. Moreover, the digital downlink time-domain user-plane data produced, and the digital uplink time-domain user-plane data received, by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to by-pass the vMU 112 and instead, for the base stations 124 coupled to that physical RF donor interface, have that physical RF donor interface perform some of the functions described here as being performed by the vMU 112 (including the digital combining or summing of user-plane data).

In the exemplary embodiment shown in FIGS. 1A-1C, the physical donor interfaces 126 also comprise one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by implementing the physical CPRI donor interface 138 as a card inserted in the physical server computer 104 and communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU that is configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive digital uplink data including combined digital user-plane data from the vMU 112, format it for the CPRI fronthaul interface, and output the CPRI formatted data to the base station 124 via the CPRI ports.

In the exemplary embodiment shown in FIGS. 1A-1C, the physical donor interfaces 126 also comprise one or more physical donor Ethernet interfaces 142. Each physical donor Ethernet interface 142 is in communication with one or more vMUs 112 executing on the physical server computer 104 in which that physical donor Ethernet interface 142 is deployed (for example, by implementing the physical donor Ethernet interface 142 as a card or module inserted in the physical server computer 104 and communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU that is configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive digital uplink fronthaul data including combined digital user-plane data for the base station 124 from the vMU 112, output it to the base station 124 via one or more Ethernet ports 144. In some implementations, each physical donor Ethernet interface 142 is implemented using standard Ethernet interfaces of the type typically used with COTS physical servers.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by implementing the physical transport Ethernet interface 146 as a card or module inserted in the physical server computer 104 and communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114 and ICNs. In some implementations, each physical transport Ethernet interface 146 is implemented using standard Ethernet interfaces of the type typically used with COTS physical servers.

In this exemplary embodiment, the virtualization software 106 is configured to implement within the virtual environment 108 a respective virtual interface for each of the physical donor interfaces 126 and physical transport Ethernet interfaces 146 in order to provide and control access to the associated physical interface by each vMU 112 implemented within that virtual environment 108. That is, the virtualization software 106 is configured so that the virtual entity 110 used to implement each vMU 112 includes or communicates with a virtual donor interface (VDI) 130 that virtualizes and controls access to the underlying physical donor interface 126. Each VDI 130 can also be configured to perform some donor-related signal or other processing (for example, each VDI 130 can be configured to process the user-plane and/or control-plane data provided by the associated physical donor interface 126 in order to determine timing and system information for the base station 124 and associated cell). Also, although each VDI 130 is illustrated in the examples shown in FIGS. 1A-1C as being separate from the respective vMU 112 with which it is associated, it is to be understood that each VDI 130 can also be implemented as a part of the vMU 112 with which it is associated. Likewise, the virtualization software 106 is configured so that the virtual entity 110 used to implement each vMU 112 includes or communicates with a virtual transport interface (VTI) 132 that virtualizes and controls access to the underlying physical transport interface 128. Each VTI 132 can also be configured to perform some transport-related signal or other processing. Also, although each VTI 132 is illustrated in the examples shown in FIGS. 1A-1C as being separate from the respective vMU 112 with which it is associated, it is to be understood that each VTI 132 can also be implemented as a part of the vMU 112 with which it is associated. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

The vDAS 100 is configured to serve each base station 124 using a respective subset of APs 114 (which may include less than all of the APs 114 of the vDAS 100). The subset of APs 114 used to serve a given base station 124 is also referred to here as the “simulcast zone” for that base station 124. Typically, the simulcast zone for each base station 124 includes multiple APs 114. In this way, the vDAS 100 increases the coverage area for the capacity provided by the base stations 124. Different base stations 124 (including different base stations 124 from different wireless service operators in deployments where multiple wireless service operators share the same vDAS 100) can have different simulcast zones defined for them. Also, the simulcast zone for each served base station 124 can change (for example, based on a time of day, day of week, etc., and/or in response to a particular condition or event).

In general, the wireless coverage of a base station 124 served by the vDAS 100 is improved by radiating a set of downlink RF signals for that base station 124 from the coverage antennas 116 associated with the multiple APs 114 in that base station's simulcast zone and by producing a single set of uplink base station signals by a combining or summing process that uses inputs derived from the uplink RF signals received via the coverage antennas 116 associated with the multiple APs 114 in that base station's simulcast zone, where the resulting final single set of uplink base station signals is provided to the base station 124.

This combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114). Each unit of the vDAS 100 that performs the combining or summing process for a given base station 124 receives uplink transport data for that base station 124 from that unit's one or more “southbound” entities, combines or sums corresponding user-plane data contained in the received uplink transport data for that base station 124 as well as any corresponding user-plane data generated at that unit from uplink RF signals received via coverage antennas 116 associated with that unit (which would be the case if the unit is a “daisy-chained” AP 114), generates uplink transport data containing the combined user-plane data for that base station 124, and communicates the resulting uplink transport data for that base station 124 to the appropriate “northbound” entities coupled to that unit. As used here, “southbound” refers to traveling in a direction “away,” or being relatively “farther,” from the vMU 112 and base station 124, and “northbound” refers to traveling in a direction “towards”, or being relatively “closer” to, the vMU 112 and base station 124. As used here, the southbound entities of a given unit are those entities that are subtended from that unit in the southbound direction, and the northbound entities of a given unit are those entities from which the given unit is itself subtended from in the southbound direction.

The vDAS 100 can also include one or more intermediary or intermediate combining nodes (ICNs) (also referred to as “expansion” units or nodes). For each base station 124 that the vDAS 100 serves using an ICN, the ICN is configured to receive a set of uplink transport data containing user-plane data for that base station 124 from a group of southbound entities (that is, from APs 114 and/or other ICNs) and perform the uplink combining or summing process described above in order to generate uplink transport data containing combined user-plane data for that base station 124, which the ICN transmits northbound towards the vMU 112 serving that base station 124. Each ICN also forwards northbound all other uplink transport data (for example, uplink management-plane and synchronization-plane data) received from its southbound entities.

In the embodiments shown in here, each ICN 103 is implemented using a respective one or more VNFs 102 deployed on one or more of the physical servers 104 (that is, is implemented in a similar manner as each vMU 112) and is also referred to here as a “virtual” ICN (vICN) 103.

In the embodiments shown in FIGS. 1A, 1C, 3A, 3C, and 3D, each vICN 103 is communicatively coupled to its northbound entities and its southbound entities using the switched Ethernet network 122 and is used only for communicating uplink transport data and is not used for communicating downlink transport data. In such embodiments, each vICN 103 includes one or more Ethernet interfaces 150 used to communicatively couple the vICN 103 to the switched Ethernet network 122. For example, each vICN 103 can include one or more Ethernet interfaces 150 that are used for communicating with its northbound entities and one or more Ethernet interfaces 150 that are used for communicating with its southbound entities. Alternatively, each vICN 103 can communicate with both its northbound and southbound entities via the switched Ethernet network 122 using the same set of one or more Ethernet interfaces 150.

In some embodiments, the vDAS 100 is configured so that some vICNs 103 also communicate (forward) southbound downlink transport data received from their northbound entities (in addition to communicating uplink transport data). In the embodiments shown in FIGS. 3A-3D, the vICNs 103 are used in this way. The ICNs 103 are communicatively coupled to their northbound entities and their southbound entities using point-to-point Ethernet links 123 and are used for communicating both uplink transport data and downlink transport data.

Generally, ICNs can be used to increase the number of APs 114 that can be served by a vMU 112 while reducing the processing and bandwidth load relative to having the additional APs 114 communicate directly with the vMU 112.

Also, one or more APs 114 can be configured in a “daisy-chain” or “ring” configuration in which transport data for at least some of those APs 114 is communicated via at least one other AP 114. Each such AP 114 would also perform the user-plane combining or summing process described above for any base station 124 served by that AP 114 in order to combine or sum user-plane data generated at that AP 114 from uplink RF signals received via its associated coverage antennas 116 with corresponding uplink user-plane data for that base station 124 received from any southbound entity subtended from that AP 114. Such an AP 114 also forwards northbound all other uplink transport data received from any southbound entity subtended from it and forwards to any southbound entity subtended from it all downlink transport received from its northbound entities.

In general, the vDAS 100 is configured to receive a set of downlink base station signals from each served base station 124, generate downlink base station data for the base station 124 from the set of downlink base station signals, generate downlink transport data for the base station 124 that is derived from the downlink base station data for the base station 124, and communicate the downlink transport data for the base station 124 over the fronthaul network 120 of the vDAS 100 to the APs 114 in the simulcast zone of the base station 124. Each AP 114 in the simulcast zone for each base station 124 is configured to receive the downlink transport data for that base station 124 communicated over the fronthaul network 120 of the vDAS 100, generate a set of downlink analog radio frequency (RF) signals from the downlink transport data, and wirelessly transmit the set of downlink analog RF signals from the respective set of coverage antennas 116 associated with that AP 114. The downlink analog RF signals are radiated for reception by UEs 118 served by the base station 124. As described above, the downlink transport data for each base station 124 can be communicated to each AP 114 in the base station's simulcast zone via one or more intermediary units of the vDAS 100 (such as one or more ICNs or daisy-chained APs 114). Also as described above, if an AP 114 is a part of a daisy chain, the AP 114 will also forward to any southbound entity subtended from that AP 114 all downlink transport received from its northbound entities.

The vDAS 100 is configured so that a vMU 112 associated with at least one base station 124 performs at least some of the processing related to generating the downlink transport data that is derived from the downlink base station data for that base station 124 and communicating the downlink transport data for the base station 124 over the fronthaul network 120 of the vDAS 100 to the APs 114 in the simulcast zone of the base station 124. In exemplary embodiments shown in FIGS. 1A-1C, a respective vMU 112 does this for all of the served base stations 124.

In general, each AP 114 in the simulcast zone of a base station 124 receives one or more uplink RF signals transmitted from UEs 118 being served the base station 124. Each such AP 114 generates uplink transport data derived from the one or more uplink RF signals and transmits it over the fronthaul network 120 of the vDAS 100. As noted above, as a part of doing this, if the AP 114 is a part of daisy chain, the AP 114 performs the user-plane combining or summing process described above for the base station 124 in order to combine or sum user-plane data generated at that AP 114 from uplink RF signals received via its associated coverage antennas 116 for the base station 124 with any corresponding uplink user-plane data for that base station 124 received from any southbound entity subtended from that AP 114. Such a daisy-chained AP 114 also forwards northbound to its northbound entities all other uplink transport data received from any southbound entity subtended from that AP 114. As described above, the uplink transport data for each base station 124 can be communicated from each AP 114 in the base station's simulcast zone over the fronthaul network 120 via one or more intermediary units of the vDAS 100 (such as one or more ICNs or daisy-chained APs 114).

The vDAS 100 is configured to receive uplink transport data for each base station 124 from the fronthaul network 120 of the vDAS 100, use the uplink transport data for the base station 124 received from the fronthaul network 120 of the vDAS 100 to generate uplink base station data for the base station 124, generate a set of uplink base station signals from the uplink base station data for the base station 124, and provide the uplink base station signals to the base station 124. As a part of doing this, the user-plane combining or summing process can be performed for the base station 124.

The vDAS 100 is configured so that a vMU 112 associated with at least one base station 124 performs at least some of the processing related to using the uplink transport data for the base station 124 received from the fronthaul network 120 of the vDAS 100 to generate the uplink base station data for the base station 124. In exemplary embodiments shown in FIGS. 1A-1C, a respective vMU 112 does this for all of the served base stations 124. As a part of performing this processing, the vMU 112 can perform at least some of the user-plane combining or summing process for the base station 124.

Also, for any base station 124 coupled to the vDAS 100 using a CPRI fronthaul interface or an Ethernet fronthaul interface, the associated vMU 112 (and/or VDI 132 or physical donor interface 126) is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 (and/or VDI 132 or physical donor interface 126) is configured to implement the control-plane, user-plane, synchronization-plane, and management-plane functions that such a RU or RRU would implement. Stated another way, in this example, the vMU 112 (and/or VDI 132 or physical donor interface 126) is configured to implement a single “virtual” RU or RRH for the associated base station 124 even though multiple APs 114 are actually being used to wirelessly transmit and receive RF signals for that base station 124.

In some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100. More specifically, in some implementations, whether user-plane data is communicated over the vDAS 100 as time-domain data or frequency-domain data depends on the functional split used to couple the associated donor base station 124 to the vDAS 100. That is, where the associated donor base station 124 is coupled to the vDAS 100 using functional split 7-2 (for example, where the associated donor base station 124 comprises an O-RAN DU that is coupled to the vDAS 100 using the O-RAN fronthaul interface), transport data communicated over the fronthaul network 120 of the vDAS 100 comprises frequency-domain user-plane data and any associated control-plane data. Where the associated donor base station 124 is coupled to the vDAS 100 using functional split 8 (for example, where the associated donor base station 124 comprises a CPRI BBU that is coupled to the vDAS 100 using the CPRI fronthaul interface) or where the associated donor base station 124 is coupled to the vDAS 100 using an analog RF interface (for example, where the associated donor base station 124 comprises a “complete” base station that is coupled to the vDAS 100 using the analog RF interface that otherwise be used to couple the antenna ports of the base station to a set of antennas), transport data communicated over the fronthaul network 120 of the vDAS 100 comprises time-domain user-plane data and any associated control-plane data.

In some implementations, user-plane data is communicated over the vDAS 100 in one form (either as time-domain data or frequency-domain data) regardless of the functional split used to couple the associated donor base station 124 to the vDAS 100. For example, in some implementations, user-plane data is communicated over the vDAS 100 as frequency-domain data regardless of the functional split used to couple the associated donor base station 124 to the vDAS 100. Alternatively, user-plane data can be communicated over the vDAS 100 as time-domain data regardless of the functional split used to couple the associated donor base station 124 to the vDAS 100. In implementations where user-plane data is communicated over the vDAS 100 in one form, user plane data is converted as needed (for example, by converting time-domain user plane data to frequency-domain user plane data and generating associated control plane data or by converting frequency-domain user plane data to time-domain user plane data and generating associated control plane data as needed).

In some such implementations, the same fronthaul interface can be used for transport data communicated over the fronthaul network 120 of the vDAS 100 for all the different types of donor base stations 124 coupled to the vDAS 100. For example, in implementations where user-plane data is communicated over the vDAS 100 in different forms, the O-RAN fronthaul interface can be used for transport data used to communicate frequency-domain user-plane data and any associated control-plane data for donor base stations 124 that are coupled to the vDAS 100 using functional split 7-2 and the O-RAN fronthaul interface can also be used for transport data used to communicate time-domain user-plane data and any associated control-plane data for donor base stations 124 that are coupled to the vDAS 100 using functional split 8 or using an analog RF interface. Also, in implementations where user-plane data is communicated over the vDAS 100 in one form (for example, as frequency-domain data), the O-RAN fronthaul interface can be used for all donor base stations 124 regardless of the functional split used to couple the associated donor base station 124 to the vDAS 100.

Alternatively, in some such implementations, different fronthaul interfaces can be used to communicate transport data for different types of donor base stations 124. For example, the O-RAN fronthaul interface can be used for transport data used to communicate frequency-domain user-plane data and any associated control-plane data for donor base stations 124 that are coupled to the vDAS 100 using functional split 7-2 and a proprietary fronthaul interface can be used for transport data used to communicate time-domain user-plane data and any associated control-plane data for donor base stations 124 that are coupled to the vDAS 100 using functional split 8 or using an analog RF interface.

In some implementations, transport data is communicated in different ways over different portions of the fronthaul network 120 of the vDAS 100. For example, the way transport data is communicated over portions of the fronthaul network 120 of the vDAS 100 implemented using switched Ethernet networking can differ from the way transport data is communicated over portions of the fronthaul network 120 of the vDAS 100 implemented using point-to-point Ethernet links 123 (for example, as a described below in connection with FIGS. 3A-3D).

In the exemplary embodiment shown in FIGS. 1A-1C, the vDAS 100, and each vMU 112, vICN 103, and AP 114 thereof, is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 100. In one example, one of the vMUs 112 is configured to serve as the timing master entity for the vDAS 100 and each of the other vMUs 112 and the vICNs 103 and APs 114 synchronizes itself to that timing master entity. In another example, a separate external timing master entity is used and each vMU 112, vICN 103, and AP 114 synchronizes itself to that external timing master entity.

In the exemplary embodiment shown in FIGS. 1A-1C, each vMU 112 (and/or the associated VDIs 130) can also be configured to process the downlink user-plane and/or control-plane data for each donor base station 124 in order to determine timing and system information for the donor base station 124 and associated cell. This can involve processing the downlink user-plane and/or control-plane data for the donor base station 124 to perform the initial cell search processing a UE would typically perform in order to acquire time, frequency, and frame synchronization with the base station 124 and associated cell and to detect the Physical layer Cell ID (PCI) and other system information for the base station 124 and associated cell (for example, by detecting and/or decoding the Primary Synchronization Signal (PSS), the Secondary Synchronization Signal (SSS), the Physical Broadcast Channel (PBCH), the Master Information Block (MIB), and System Information Blocks (SIBs)). This timing and system information for a donor base station 124 can be used, for example, to configure the operation of the vDAS 100 (and the components thereof) in connection with serving that donor base station 124.

In order to reduce the latency associated with implementing each vMU 112 or vICN 103 in a virtualized environment 108 running on a COTS physical server 104, input-output (IO) operations associated with communicating data between a vMU 112 and a physical donor interface 126 and/or between a vMU 112 and a physical transport interface 128, as well as any baseband processing performed by a vMU 112, associated VDI 130, or vICN 103 can be time-sliced to ensure that such operations are performed in a timely manner. With such an approach, the tasks and threads associated with such operations and processing are executed in dedicated times slices without such tasks and threads being preempted by, or otherwise having to wait for the completion of, other tasks or threads.

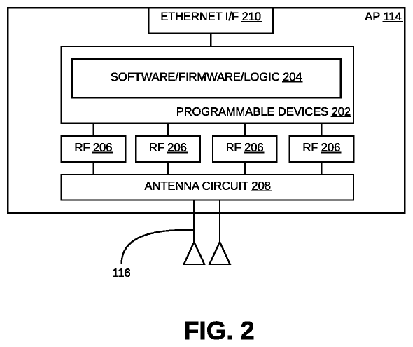

FIG. 2 is a block diagram illustrating one exemplary embodiment of an access point 114 that can be used in the vDAS 100 of FIGS. 1A-1C.

The AP 114 comprises one or more programmable devices 202 that execute, or are otherwise programmed or configured by, software, firmware, or configuration logic 204 in order to implement at least some functions described here as being performed by the AP 114 (including, for example, physical layer (Layer 1) baseband processing described here as being performed by a radio unit (RU) entity implemented using that AP 114). The one or more programmable devices 202 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way. In general, the programmable devices 202 and software, firmware, or configuration logic 204 are scaled so as to be able implement multiple logical (or virtual) RU entities using the (physical) AP 114. The various functions described here as being performed by an RU entity are implemented by the programmable devices 202 and one or more of the RF modules 206 (described below) of the AP 114.

In general, each RU entity implemented by an AP 114 is associated with, and serves, one of the base stations 124 coupled to the vDAS 100. The RU entity communicates transport data with each vMU 112 serving that AP 114 using the particular fronthaul interface used for communicating over the fronthaul network 120 for the associated type of base station 124 and is configured to implement the associated fronthaul interface related processing (for example, formatting data in accordance with the fronthaul interface and implementing control-plane, management-plane, and synchronization-plane functions). The O-RAN fronthaul interface is used in some implementations of the exemplary embodiment described here in connection with FIGS. 1A-1C and 2. In addition, the RU entity performs any physical layer baseband processing that is required to be performed in the RU.

Normally, when a functional split 7-2 is used, some physical layer baseband processing is performed by the DU or BBU and the remaining physical layer baseband processing and the RF functions are performed by the corresponding RU. The physical layer baseband processing performed by the DU or BBU is also referred to as the “high” physical layer baseband processing, and the baseband processing performed by the RU is also referred to as the “low” physical layer baseband processing.

As noted above, in some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user plane data (and associated control-plane data) and the RU entity for that base station 124 performs the low physical layer baseband processing and the RF functions in addition to performing the processing related to communicating the transport data over the fronthaul network 120 of the vDAS 100. Where the associated base station 124 comprises a DU or BBU that is configured to use functional split 8 or a where the associated base station 124 comprises a “complete” base station that is coupled to a vMU 112 using an analog RF interface, the transport data comprises time-domain user plane data (and associated control-plane data) and the RU entity for that base station 124 performs the RF functions for the base station 124 in addition to performing the processing related to communicating the transport data over the fronthaul network 120 of the vDAS 100.

It is possible for a given AP 114 to communicate and process transport data for different base stations 124 served by that AP 114 in different ways. For example, a given AP 114 may serve a first base station 124 that uses functional split 7-2 and a second base station 124 that uses functional split 8, in which case the corresponding RU entity implemented in that AP 114 for the first base station 124 performs the low physical layer processing for the first base station 124 (including, for example, the inverse fast Fourier transform (iFFT) processing for the downlink data and the fast Fourier transform (FFT) processing for the uplink data), whereas the corresponding RU entity implemented in the AP 114 for the second base station 124 does not perform such low physical layer processing for the second base station 124.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user plane data (and associated control-plane data), regardless of the functional split used by the associated base station 124. In such implementations, the vMU 112 converts the user plane data as needed (for example, by converting the time-domain user plane data to frequency-domain user-plane data and generating associated control-plane data).

In general, the physical layer baseband processing required to be performed by an RU entity for a given served base station 124 depends on the functional split used for the transport data.

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions) including filtering and combining.

In one exemplary implementation, the uplink RF analog signal (including the various physical channels and associated sub carriers) received by each coverage antenna 116 is provided, via the antenna circuit 208, to an associated uplink signal path in each RF module 206.

Each uplink signal path in each RF module 206 receives the uplink RF analog received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filter and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the associated vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports of the base station 124. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated sub carriers) output by the base station 124 and generate the downlink base station data by generating corresponding time-domain baseband in-phase and quadrature (IQ) data from the received download analog RF signals (for example, by performing an analog-to-digital (ADC) and digital down conversion process on the received downlink analog RF signal). The generated downlink base station data is provided to the vMU 112 (for example, by communicating it over a PCIe lane to a CPU used to execute the vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to a RU. In this example, the physical donor interface 126 used to receive the one or more downlink base station signals comprises a physical CPRI donor interface 138. Each downlink CPRI fronthaul signal is received by a CPRI port of the physical CPRI donor interface 138 installed in the physical server computer 104 executing the vMU 112. The physical CPRI donor interface 138 is configured to receive each downlink CPRI fronthaul signal, generate downlink base station data by extracting various information flows that are multiplexed together in CPRI frames or messages that are communicated via the downlink CPRI fronthaul signal, and provide the generated downlink base station data to the vMU 112 (for example, by communicating it over a PCIe lane to a CPU used to execute the vMU 112). The extracted information flows can comprise CPRI user-plane data, CPRI control-and-management-plane data, and CPRI synchronization-plane data. That is, in this example, the downlink base station data comprises the various downlink information flows extracted from the downlink CPRI frames received via the downlink CPRI fronthaul signals. Alternatively, the downlink base station data can be generated by extracting downlink CPRI frames or messages from each received downlink CPRI fronthaul signal, where the extracted CPRI frames are provided to the vMU 112 (for example, by communicating them over a PCIe lane to a CPU used to execute the vMU 112).

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to a RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating them over a PCIe lane to a CPU used to execute the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 over the fronthaul network 120 to the set of APs 114 serving the base station 124. As described above, the downlink transport data for each base station 124 can be communicated to each AP 114 in the base station's simulcast zone via one or more intermediary units of the vDAS 100 (such as one or more ICNs or daisy-chained APs 114).

The downlink transport data generated for a base station 124 is communicated by the vMU 112 over the fronthaul network 120 so that downlink transport data for the base station 124 is received at the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation where the O-RAN fronthaul interface is used for the transport data, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114 or for it to be suitable for use with the fronthaul interface used for communicating over the fronthaul network 120 of the vDAS 100. For example, in one exemplary embodiment described here in connection with FIGS. 1A-1C and 2 where the vDAS 100 is configured to use an O-RAN fronthaul interface for communications between the vMU 112 and the APs 114, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100.

In those implementations where both the content of the transport data and the manner in which it is generated depend on the functional split and/or fronthaul interface used to couple the associated base station 124 to the vDAS 100, if the base station 124 comprises a DU or BBU that is coupled to the vDAS 100 using a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is coupled to the vDAS 100 using functional split 8 or where a base station 124 comprises a “complete” base station that is coupled to the vDAS 100 using an analog RF interface, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which it is generated is generally the same for all donor base stations 124, regardless of the functional split and/or fronthaul interface used to couple each donor base station 124 to the vDAS 100, all downlink transport data is generated in accordance with a functional split 7-2 where the corresponding user-plane data is communicated as frequency-domain user-plane data. For example, where a base station 124 comprises a DU or BBU that is coupled to the vDAS 100 using functional split 8 or where a base station 124 comprises a “complete” base station that is coupled to the vDAS 100 using an analog RF interface, the downlink base station data for the base station 124 comprises time-domain user-plane data for each antenna port of the base station 124 and the vMU 112 converts it to frequency-domain user-plane data and generates associated control-plane data in connection with generating the downlink transport data that is communicated between each vMU 112 and each AP 114 in the base station's simulcast zone. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with each such AP 114.

Where multicast addresses and/or VLANs are used for transmitting the downlink transport data to the APs 114 in a base station's simulcast zone, each AP 114 in the simulcast zone will receive the downlink transport data transmitted by the vMU 112 using that multicast address and/or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, a RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, a RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated sub carriers) via the set of coverage antennas 116 associated with that AP 114, generates uplink transport data from the received uplink RF analog signals, and communicates the uplink transport data from each AP 114 over the fronthaul network 120 of the vDAS 100. The uplink transport data is communicated over the fronthaul network 120 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receive uplink transport data derived from the uplink transport data transmitted from the APs 114 in the simulcast zone of the base station 124, generates uplink base station data from the received uplink transport data, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124. As described above, the uplink transport data can be communicated from the APs 114 in the simulcast zone of the base station 124 to the vMU 112 coupled to the base station 124 via one or more intermediary units of the vDAS 100 (such as one or more ICNs or daisy-chained APs 114).

As described above, a single set of uplink base station signals are produced for each donor base station 124 using a combining or summing process that uses inputs derived from the uplink RF signals received via the coverage antennas 116 associated with the multiple APs 114 in that base station's simulcast zone, where the resulting final single set of uplink base station signals is provided to the base station 124. Also, as noted above, this combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114).

How the corresponding user-plane data is combined or summed depends on the functional split used for communicating transport data between the vMUs 112 and the APs 114.

The form that the uplink base station signals take and how the uplink base station signals are generated from the uplink base station data also depend on how the base station 124 is coupled to the vDAS 100.

For example, where an Ethernet-based fronthaul interface is used (such as O-RAN, eCPRI, or RoE) to couple the base station 124 to the vDAS 100, the vMU 112 is configured to format the uplink base station data into messages formatted in accordance with the associated Ethernet-based fronthaul interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, in one implementation, the uplink base station data comprises the various information flows that are multiplexed together in uplink CPRI frames or messages and the vMU 112 is configured to generate these various information flows in accordance with the CPRI fronthaul interface. In such an implementation, the information flows are provided to the associated physical CPRI donor interface 138. The physical CPRI donor interface 138 uses these information flows to generate CPRI frames for communicating to the base station 124 via one or more CPRI ports of that physical CPRI donor interface 138. That is, in this example, the “uplink base station signals” comprise the physical-layer signals used to communicate such CPRI frames. Alternatively, in another implementation, the uplink base station data comprises CPRI frames or messages, which the VMU 112 is configured to produce and provide to the associated physical CPRI donor interface 138 for use in producing the physical-layer signals used to communicate the CPRI frames to the base station 124.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital up conversion and digital-to-analog (DAC) process). For each antenna port of the base station 124, the physical RF donor interface 134 outputs the respective uplink analog RF signal (including the various physical channels and associated sub carriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN or TEN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 or vICN 103 because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways.

For example, FIGS. 3A-3D illustrates one such embodiment.

FIGS. 3A-3D are block diagrams illustrating exemplary embodiments of vDAS 300 in which at least some of the APs 314 are coupled to one or more vMU 112 serving them via one or more virtual ICNs 103. In the embodiments shown in 3A-3D, each vICN 103 includes multiple Ethernet interfaces 150, one or more of which are used to couple the vICN 103 to the respective northbound entities for that vICN 103 and one or more of which are used to couple the vICN 103 to the respective southbound entities for that vICN 103. The Ethernet interfaces 150 used to couple the vICN 103 to the respective northbound entities for that vICN 103 are also referred to here as “northbound” Ethernet interfaces 150, and the Ethernet interfaces 150 used to couple the vICN 103 to the respective southbound entities for that vICN 103 are also referred to here as “southbound” Ethernet interfaces 150.

Except as explicitly described here in connection with FIGS. 3A-3D, the vDAS 300 and the components thereof (including the vMU 112 and vICNs 103) are configured as described above. Also, except as explicitly described here in connection with FIGS. 3A-3D, each AP 314 is implemented in the same manner as the APs 114 described above.

As noted above, the fronthaul network 320 used for transport between each vMU 112 and the APs 114 and vICNs 103 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each vICN 103 (and the APs 314 coupled thereto) to each vMU 112 serving that AP 114 or 314 or vICN 103.

In the example shown in FIG. 3B, the fronthaul network 320 is implemented using only point-to-point Ethernet links 123 or 323, where each AP 114 and each vICN 103 (and the APs 314 coupled thereto) is coupled to each serving vMU 112 serving it via a respective one or more point-to-point Ethernet links 123 or 323. In the example shown in FIG. 3C, the fronthaul network 320 is implemented using a combination of a switched Ethernet network 322 and point-to-point Ethernet links 123 or 323. In the example shown in FIG. 3D, a first vICN 103 has a second vICN 103 subtended from it so that some APs 314 are communicatively coupled to the first vICN 103 via the second vICN 103. Again, as noted above, it is to be understood that FIGS. 1A-1C and 3A-3D illustrate only a few examples of how the fronthaul network (and the vDAS more generally) can be implemented and that other variations are possible.

In one implementation of the embodiments shown in FIGS. 3A-3D, each vMU 112 that serves each vICN 103 treats the vICN 103 as one or more “virtual APs” to which it sends downlink transport data for one or more base stations 124, and from which it receives uplink transport data, for the one or more base stations 124. The vICN 103 forwards the downlink transport data to, and combines uplink transport data received from, one or more of the APs 314 coupled to the vICN 103. In one implementation of such an embodiment, the vICN 103 forwards the downlink transport data it receives for all the served base stations 124 to all of the APs 314 coupled to the vICN 103 and combines uplink transport data it receives from all of the APs 314 coupled to the vICN 103 for all of the base stations 124 served by the vICN 103.

In another implementation of the embodiments shown in FIGS. 3A-3D, each vICN 103 is configured so that a separate subset of the APs 314 coupled to that vICN 103 can be specified for each base station 124 served by that vICN 103. In such an implementation, for each base station 124 served by a vICN 103, the vICN 103 forwards the downlink transport data it receives for that base station 124 to the respective subset of the APs 314 specified for that base station 124 and combines the uplink transport data it receives from the subset of the APs 314 specified for that base station 124. That is, in this implementation, each vICN 103 can be used to forward the downlink transport data for different served base stations 124 to different subsets of APs 314 and to combine uplink transport data the vICN 103 receives from different subsets of APs 314 for different served base stations 124. Various techniques can be used to do this. For example, the vICN 103 can be configured to inspect one or more fields (or other parts) of the received transport data to identify which base station 124 the transport data is associated with. In another implementation, the vICN 103 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each vICN 103 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to a vICN 103 is configured to synchronize itself to the time base used in the rest of the vDAS 300 based on the synchronous Ethernet communications provided from the vICN 103.

In one example of the operation of the vDAS 300 of FIGS. 3A-3D, in the downlink direction, each vICN 103 receives downlink transport data for the base stations 124 served by that vICN 103 and communicates, using the southbound Ethernet interfaces of the vICN 103, the downlink transport data to one or more of the APs 314 coupled to vICN 103. As noted above, in one implementation, each vMU 112 that is coupled to a base station 124 served by a vICN 103 treats the vICN 103 as a virtual AP and addresses downlink transport data for that base station 124 to the vICN 103, which receives it using a northbound Ethernet interface.

As noted above, for each served base station 124, each ICN 103 forwards the downlink transport data it receives from the serving vMU 112 for that base station 124 to one or more of the APs 314 coupled to the vICN 103. For example, as noted above, the vICN 103 can be configured to simply forward the downlink transport data it receives for all served base stations 124 to all of the APs 314 coupled to the vICN 103 or the vICN 103 can be configured so that a separate subset of the APs 314 coupled to the vICN 103 can be specified for each served base station 124, where the vICN 103 is configured to forward the downlink transport data it receives for each served base station 124 to only the specific subset of APs 314 specified for that base station 124.

Each AP 314 coupled to the vICN 103 receives the downlink transport data to it, generates respective sets of downlink analog RF signals for all base stations 124 served by the vICN 103, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the vICN 103 as described above. That is, how each AP 314 generates the set of downlink analog RF signals using the downlink transport data depends on the functional split used for communicating transport data between the vMUs 112, vICNs 103, and the APs 114 and 314. For example, where the downlink transport data comprises frequency-domain user-plane data and associated control-plane data for each antenna port of the base station 124, a RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, a RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the vICN 103 that is used to serve a base station 124 receives a respective set of uplink RF analog signals (including the various physical channels and associated sub carriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, vICNs 103, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the vICN 103. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the vICN 103.

Each vICN 103 receives respective uplink transport data transmitted from any subtended APs 314 or other vICNs 103. The respective uplink transport data transmitted from any subtended APs 314 and/or subtended vICNs 103 is received by the vICN 103 using the respective southbound Ethernet interfaces 150.

The vICN 103 extracts the respective uplink transport data for each served base station 124 and, for each served base station 124, combines or sums corresponding user-plane data included in the extracted uplink transport data received from the one or more subtended APs 314 and/or vICNs 103 coupled to that vICN 103 used to serve that base station 124. The manner in which each vICN 103 combines or sums the user-plane data depends on whether the user-plane data comprises time-domain data or frequency-domain data. Generally, the vICN 103 combines or sums the user-plane data in the same way that each vMU 112 does so.

Each vICN 103 generates uplink transport data for each served base station 124 that includes the respective combined user-plane data for that base station 124 and communicates the uplink transport data including combined user-plane data for each served base station 124 to the vMU 112 associated with that base station 124 or to an upstream vICN 103. In this exemplary embodiment described here in connection with FIGS. 3A-3D where the O-RAN fronthaul interface is used for communicating over the fronthaul network 120, each vICN 103 is configured to generate and format the uplink transport data in accordance with that O-RAN fronthaul interface.

As noted above, each vICN 103 shown in FIGS. 3A-3D can be used to increase the number of APs 314 that can be served by a vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to by-pass the vMU 112.

Except as explicitly described here in connection with FIG. 4, the vDAS 400 and the components thereof are configured as described above.

In the exemplary embodiment shown in FIG. 4, the vDAS 400 includes at least one “by-pass” physical RF donor interface 434 that is configured to bypass the vMU 112 and instead, for the base stations 124 coupled to that physical RF donor interface 434, have that physical RF donor interface 434 perform at least some of the functions described above as being performed by the vMU 112. These functions include, for the downlink direction, receiving a set of downlink RF analog signals from each base station 124 coupled to the by-pass physical RF donor interface 434, generating downlink transport data from the set of downlink RF analog signals and communicating the downlink transport data to one or more of the APs or vICNs and, in the uplink direction, receiving respective uplink transport data from one or more APs or vICNs, generating a set of uplink RF analog signals from the received uplink transport data (including performing any digital combining or summing of user-plane data), and providing the uplink RF analog signals to the appropriate base stations 124. In this exemplary embodiment, each by-pass physical RF donor interface 434 includes one or more physical Ethernet transport interfaces 448 for communicating the transport data to and from the APs 114 and vICNs. The vDAS 400 (and the by-pass physical RF donor interface 434) can be used with any of the configurations described above (including, for example, those shown in FIGS. 1A-1C and FIGS. 3A-3D).

Each by-pass physical RF donor interface 434 comprises one or more programmable devices 450 that execute, or are otherwise programmed or configured by, software, firmware, or configuration logic 452 in order to implement at least some of the functions described here as being performed by the by-pass physical RF donor interface 434 (including, for example, any necessary physical layer (Layer 1) baseband processing). The one or more programmable devices 450 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The by-pass physical RF donor interface 434 can be used to reduce the overall latency associated with serving the base stations 124 coupled to that physical RF donor interface 434.

In one implementation, the by-pass physical RF donor interface 434 is configured to operate in a fully standalone mode in which the by-pass physical RF donor interface 434 performs substantially all “master unit” processing for the donor base stations 124 and APs and vICNs that it serves. For example, in such a fully standalone mode, in addition to the processing associated with generating and communicating user-plane and control-plane data over the fronthaul network 120, the by-pass physical RF donor interface 434 can also execute software that is configured to use a time synchronization protocol (for example, the IEEE 1588 PTP or SyncE protocol) to synchronize the by-pass physical RF donor interface 434 to a timing master entity established for the vDAS 100. In such a mode, the by-pass physical RF donor interface 434 can itself serve as a timing master for the APs and other nodes (for example, vICNs) served by that by-pass physical RF donor interface 434 or instead have another entity serve as a timing master for the APs and other nodes (for example, vICNs) served by that by-pass physical RF donor interface 434.

In such a fully standalone mode, the by-pass physical RF donor interface 434 can also execute software that is configured to process the downlink user-plane and/or control-plane data for each donor base station 124 in order to determine timing and system information for the donor base station 124 and associated cell (which, as described, can involve processing the downlink user-plane and/or control-plane data to perform the initial cell search processing a UE would typically perform in order to acquire time, frequency, and frame synchronization with the base station 124 and associated cell and to detect the PCI and other system information for the base station 124 and associated cell (for example, by detecting and/or decoding the PSS, the SSS, the PBCH, the MIB, and SIBs). This timing and system information for a donor base station 124 can be used, for example, to configure the operation of the by-pass physical RF donor interface 434 and/or the vDAS 100 (and the components thereof) in connection with serving that donor base station 124. In such a fully standalone mode, the by-pass physical RF donor interface 434 can also execute software that enables the by-pass physical RF donor interface 434 to exchange management-plane messages with the APs and other nodes (for example, vICNs) served by that by-pass physical RF donor interface 434 as well as with any external management entities coupled to it.

In other modes of operation, at least some of the “master unit” processing for the donor base stations 124 and APs and vICNs that the by-pass physical RF donor interface 434 serves are performed by a vMU 112. For example, the vMU 112 can serve as a timing master and the by-pass physical RF donor interface 434 can execute software that causes the by-pass physical RF donor interface 434 to serve as a timing sub-ordinate and exchange timing messages with the vMU 112 to enable the by-pass physical RF donor interface 434 to synchronize itself to the timing master. In such other modes, the by-pass physical RF donor interface 434 can itself serve as a timing master for the APs and other nodes (for example, vICNs) served by that by-pass physical RF donor interface 434 or instead have the vMU 112 (or other entity) serve as a timing master for the APs and other nodes (for example, vICNs) served by that by-pass physical RF donor interface 434. In such other modes, the vMU 112 can also execute software that is configured to process the downlink user-plane and/or control-plane data for each donor base station 124 served by the by-pass physical RF donor interface 434 in order to determine timing and system information for the donor base station 124 and associated cell. In connection with doing this, the by-pass physical RF donor interface 434 provides the required downlink user-plane and/or control-plane data to the vMU 112. In such other modes, the vMU 112 can also execute software that enables it to exchange management-plane messages with the by-pass physical RF donor interface 434 and the APs and other nodes (for example, vICNs) served by the by-pass physical RF donor interface 434 as well as with any external management entities coupled to it. In such other modes, data or messages can be communicated between the by-pass physical RF donor interface 434 and the vMU 112, for example, over the fronthaul switched Ethernet network 122 (which is suitable if the by-pass physical RF donor interface 434 is physically separate from the physical server computer 104 used to execute the vMU 112) or over a PCIe lane to a CPU used to execute the vMU 112 (which is suitable if the by-pass physical RF donor interface 434 is implemented as a card inserted into a slot of the physical server computer 104 used to execute the vMU 112).

The by-pass physical RF donor interface 434 can be configured and used in other ways.

In the following description, embodiments are described in connection with the vDAS 100 shown in FIGS. 1A-1C. However, it should be understood that such embodiments can also be implemented using other embodiments of a vDAS, including without limitation vDAS 300 shown FIGS. 3A-3D and vDAS 400 shown in FIG. 4.

When deploying a vDAS 100, the physical servers 104 on which the various virtual nodes of the vDAS 100 are implemented must be obtained. For example, in some situations, the customer of the vDAS 100 must purchase, or otherwise obtain access to, the physical servers on which the various nodes and functions of the vDAS 100 are implemented.

Traditionally, the vendor of software identifies minimum hardware specifications for the physical servers on which the software is to be executed and any other resources used by the software (such network resources). However, this limits the flexibility of the customer to purchase or otherwise obtain access to the physical servers on which the software is to be executed and the other resources used by the software, especially if the minimum hardware specifications for the physical servers identified by the software vendor or other resources used by the software are for a target use case (and associated target configuration) for the software that differs from the customer's intended use case (and associated intended configuration) for the software.

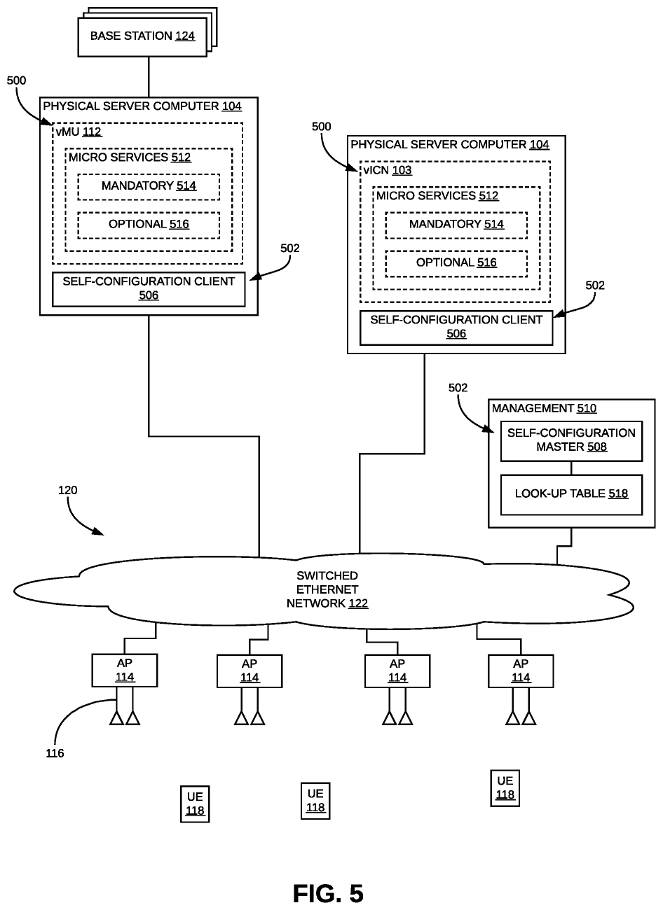

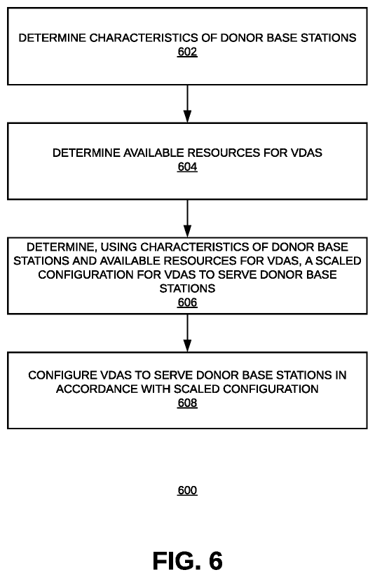

One approach to dealing with this issue is described below in connection with FIGS. 5-6.

FIG. 5 is a simplified block diagram illustrating some additional implementation details for the virtual distributed antenna systems shown above.

As shown in FIG. 5, the vDAS 100 is implemented by executing scalable vDAS software 500 in the respective virtualized environment 108 created on each of the set of one or more physical server computers 104 used to implement the vDAS 100. The scalable vDAS software 500 is executed in order to carry out one or more roles for the vDAS 100. The one or more roles for the vDAS 100 include, for example, vMU roles and vICN roles. The scalable vDAS software 500 can be scaled in order to increase or decrease the amount of resources used by the scalable vDAS software 500 in connection with implementing the vDAS 100.

One or more self-configuration entities 502 are used with the vDAS 100 in order to automatically determine characteristics of the donor base stations 124 and the resources that are available to implement the vDAS 100 and to automatically configure the vDAS 100 (and, more specifically, the scalable vDAS software 500 and the donor base stations 124) accordingly. One example of how this can be done is described below in connection with FIG. 6.

FIG. 6 comprises a high-level flowchart illustrating one exemplary embodiment of a method 600 of configuring a virtualized distributed antenna system (vDAS). The embodiment of method 600 shown in FIG. 6 is described here as being implemented using the vDAS 100 (and the variants thereof) described above. However, it is to be understood that other embodiments can be implemented in other ways.

The blocks of the flow diagram shown in FIG. 6 have been arranged in a generally sequential manner for ease of explanation; however, it is to be understood that this arrangement is merely exemplary, and it should be recognized that the processing associated with method 600 (and the blocks shown in FIG. 6) can occur in a different order (for example, where at least some of the processing associated with the blocks is performed in parallel and/or in an event-driven manner). Also, most standard exception handling is not described for ease of explanation; however, it is to be understood that method 600 can and typically would include such exception handling. Moreover, one or more aspects of method 600 can be configurable or adaptive (either manually or in an automated manner).

Method 600 comprises determining characteristics of the set of one or more donor base stations 124 served by the vDAS 100 (block 602) and determining resources that are available to implement the vDAS 100 (block 604). The resources that are available to implement the vDAS 100 are also referred to here as the “available” resources for the vDAS 100.

Method 600 further comprises determining, using the characteristics of the one or more donor base stations 124 and the available resources for the vDAS 100, a scaled configuration for the vDAS 100 to serve the donor base stations 124 (block 606). The scaled configuration is scaled so that the available resources for the vDAS 100 are sufficient to implement the vDAS 100 in accordance with the target configuration. Method 600 further comprises configuring the vDAS 100 to serve the donor base stations 124 in accordance with the scaled configuration by executing the scalable vDAS software 500 on each of the physical server computers 104 in accordance with the scaled configuration (block 608).

The one or more self-configuration entities 502 can be configured to implement method 600.

As shown in FIG. 5, the one or more self-configuration entities 502 can comprise software that is executed as a part of the management-plane implemented for the vDAS 100. This software can be available for use during the life of the vDAS 100 deployment (for example, to automatically and dynamically determine the characteristics of the donor base stations 124 and the available resources for the vDAS 100 and adjust the scaled configuration for the vDAS 100 accordingly) or can be available for use only during specific times during the life of the vDAS 100 (such as during initial installation and provisioning of the vDAS 100 and when the hardware used for the vDAS 100 changes (for example, when one or more physical servers 104 and/or donor base stations 124 are added, removed, or changed and/or when the fronthaul network 120 implementation changes)). The one or more self-configuration entities 502 can be implemented in other ways. The one or more self-configuration entities 502 can also comprise standalone software that is deployed and used only during installation and provisioning of the vDAS 100 and when the hardware used for the vDAS 100 changes.

In the example shown in FIG. 5, the software used to implement the one or more self-configuration entities 502 can comprise self-configuration client software 506 that is configured to execute on each of the one or more physical servers 104 used to implement the vDAS 100 and self-configuration master software 508 configured to communicate with the self-configuration client software 506. The self-configuration master software 508 can, for example, be implemented as a part of a management system 510 that is otherwise used to manage the vDAS 100 and/or be implemented as separate or standalone software.

In this example, the self-configuration client software 506 executing on each physical server computer 104 is configured to determine the available resources provided by, or that are otherwise available to, that physical server 104 and communicate, to the self-configuration master software 508, information about such available resources. The self-configuration client software 506 can also be configured to determine at least some of the characteristics of any donor base stations 124 coupled to the physical server computer 104 on which the self-configuration client software 506 is executed and communicate, to the self-configuration master software 508, information about any such characteristics.

The self-configuration master software 508 can also be configured to determine the characteristics of the donor base stations 124 by communicating with the donor base stations 124 and/or by communicating with a management entity associated with the donor base stations 124 that has information about the characteristics of the donor base stations 124. The self-configuration master software 508 can also be configured to determine information about the fronthaul network 120 by communicating with devices used to implement the fronthaul network 120 (for example, Ethernet switches) and/or by communicating with a management entity associated with the fronthaul network 120 that has information about the resources provided by the fronthaul network 120.

The characteristics of the donor base stations 124 can include one or more of the following: donor interface types supported by each donor base station 124 (for example, whether the donor base station 124 supports an analog RF donor interface, CPRI donor interface, or an O-RAN donor interface), radio unit entity configurations supported by each donor base station 124 (for example, whether the donor base station 124 natively supports using multiple RPs, RRHs, or RUs to serve a single cell or sector and/or a minimum and maximum number of RUs the donor base station 124 requires to serve a single cell or sector), air interface protocols or standards (for example, 5G NR, 4G LTE, etc.) supported by each donor base station 124, air interface bandwidths supported by each donor base station 124, duplexing schemes supported by each donor base station 124 (for example, FDD and TDD duplexing schemes supported by the donor base station 124), end-to-end (E2) latency requirements for each donor base station 124, the number of antenna ports or MIMO layers supported by each donor base station 124 (for example, how MIMO layers or antennas supported by the donor base station 124), and numerologies supported by each donor base station 124 (for example, which 5G NR numerologies are supported by the donor base station 124).

The available resources for the vDAS 100 can include at least one of: resources provided by the set of one or more physical server computers 104, bandwidth and other characteristics of communication connectivity used for communications between nodes of the vDAS 100, and bandwidth and other characteristics of communication connectivity used for communications between the set of donor base stations 124 and the vDAS 100. For example, the available resources that are available to implement the vDAS 100 can include at least one of: processor cores provided by the physical server computers 104, clock frequency provided by the physical server computers 104, central processor unit (CPU) make, model, or architecture provided by the physical server computers 104, memory provided by the physical server computers 104, Ethernet bandwidth supported by the physical server computers 104, an operating system provided by each of the physical server computers 104, Peripheral Component Interconnect Express (PCIe) configuration provided by the physical server computers 104, threading/hyperthreading configuration and resources provided by the physical server computers 104, input-output (IO) acceleration provided by the physical server computers 104, socket configuration provided by the physical server computers 104, CPU pinning or isolation provided by the physical server computers 104, and non-uniform memory access (NUMA) awareness provided by the physical server computers 104.

In one exemplary embodiment, the scalable software 500 used to implement the vDAS 100 can be implemented as a set of services (also referred to here as “micro services”) 512 for the various roles of the vDAS 100. The scalable software 500 can be scaled, for example, by increasing or reducing the number of micro services 512 executed and/or by changing how, and/or for what the, micro services 512 are performed (for example, by changing the amount of data processed by a micro service 512 (for example, by changing the number of antenna carriers and/or access points 114 used to serve a given donor base station 124) and/or by changing how frequently a micro service 502 is performed).

Each of the micro services 512 implements one or more functions of (or for) that role of the vDAS 100. The micro services 512 can be deployed and scaled using the resources provided by the underlying physical servers 104 and other resources (such as the fronthaul network 120). Some of the micro services 512 are mandatory (or basic or core) services 514 that must be provided in some form in order for the vDAS 100 to operate at a basic level. Some of the micro services 512 are optional services 516 that do not need to be provided in some form in order for the vDAS 100 to operate at a basic level but that provide a function or service that may otherwise be desirable.

For example, the set of micro services 512 implemented for the vMU and vICN roles include mandatory micro services 514 and optional micro services 516. The mandatory micro services 514 implemented for the vMU role can include “donor” services related to communicating downlink and uplink data (including for example, downlink and uplink control-plane, user-plane, synchronization-plane, and management-plane data) for each donor base station 124 between the vDAS 100 (and, in particular, a vMU 112) and that donor base station 124 or another entity associated with the donor base station 124 (such as a management or synchronization entity). In connection with doing this, the donor services implement processing necessary to support the fronthaul interface and functional split natively supported by that donor base station 124 as well as any interface or protocol natively used by any other entity associated with that donor base station 124 with which the vMU 112 must exchange downlink and uplink data in connection with serving that donor base station 124.

The mandatory micro services 514 implemented for the vMU role can also include “access” services relating to communicating downlink and uplink data (including for example, downlink and uplink control-plane, user-plane, synchronization-plane, and management-plane data) for each donor base station 124 to and from the access points 114 and/or vICNs 103 used to serve that donor base station 124. In connection with doing this, the access services implement processing necessary to support the fronthaul interface used by the vDAS 100 for communicating over the fronthaul network with the access points 114 and/or vICNs 103.

The mandatory micro services 514 implemented for the vMU role can also include mandatory management-plane functions such as assigning and/or tracking the Internet Protocol (IP) (or other protocol) addresses of the nodes of the vDAS 100 and any associated virtual local area networks (vLANs) and multicast groups used for communicating over the switched Ethernet network 122, defining the simulcast zones for each donor base station 124, defining how fronthaul traffic will be routed within the vDAS 100 (which includes, for example, determining which nodes will forward uplink data to a vICN 103 for aggregation), and defining which timing sources should be used by the various nodes of the vDAS 100. The mandatory micro services 514 implemented for the vMU role can also include mandatory timing or synchronization-plane services such as synchronizing the vMU 112 to a timing master (for example, using IEEE 1588, PTP, NTP, GPS, etc.) and providing a local timing master for other nodes subtended from that vMU 112 (for example, for access points 114 and/or vICNs 103).

The mandatory micro services 514 implemented for the vICN role can include services related to receiving uplink data from southbound entities subtended from the vICN 103, performing the uplink user-plane summing or combining process described above, communicating the resulting combined user-plane data to one or more northbound entities from which the vICN 103 is subtended, and forwarding any other uplink data received from its southbound entities to one or more northbound entities from which the vICN 103 is subtended. In embodiments where a vICN 103 is also used to communicate downlink data, the mandatory micro services 514 for such a vICN 103 can also include receiving downlink data from one or more northbound entities from which the vICN 103 is subtended and forwarding at least some of the downlink data received from the northbound entities to one or more southbound entities subtended from the VICN 103.

The mandatory micro services 514 implemented for the vICN role can also include mandatory management-plane functions such as configuring the vICN 103 in accordance with, or otherwise processing or responding to, any management-plane messages received by the vICN 103 that are intended for that vICN 103 and mandatory synchronization-plane functions such as synchronizing the vICN 103 to a timing master in accordance with any synchronization-plane messages received by the vICN 103 that are intended for that vICN 103.

The mandatory micro services 514 implemented for the vMU and/or vICN roles can include other services or functions.

The optional micro services 516 implemented for the vMU and/or vICN roles can include features that enable the vDAS 100 to natively support implementing multiple “virtual” RRH, RP, or RU entities for a given donor base station 124 in way that enables each such a donor base station 124 to individually communicate and interact with each of the virtual multiple RRH, RP, or RU entities implemented for that donor base station 124 as well as implementing any special functions or features used by such a donor base station 124 to take advantage of the multiple RRH, RP, or RU entities. By implementing such special multi-RU features and by being able to instantiate multiple virtual RUs for any such multi-RU donor base station 124, those multi-RU features implemented by the multi-RU donor base station 124 that use multiple RUs, RPs, or RRHs can still be used when the multi-RU donor base station 124 is used with the vDAS 100.

Examples of such multi-RU features include uplink interference rejection combining (IRC) receivers, noise muting receivers, or selection combining receivers, downlink frequency reuse, and uplink frequency reuse. Uplink IRC receivers, noise muting receivers, or selection combining receivers implemented by a multi-RU donor base station 124 use user-plane data received via the multiple RUs in performing the uplink receiver processing for each UE. Also, in this context, “downlink frequency reuse” refers to situations where separate downlink user data intended for different UEs is simultaneously wirelessly transmitted to the UEs using the same physical resource blocks (PRBs) for the same cell. Likewise, “uplink frequency reuse” refers to situations where separate uplink user data is simultaneously wirelessly transmitted from different UEs using the same PRBs for the same cell. Typically, frequency reuse can be used when the UEs “in reuse together” are sufficiently physically separated from each other so that the co-channel interference resulting from the different simultaneous wireless transmissions is sufficiently low (that is, where there is sufficient RF isolation). Generally, for those PRBs where downlink or uplink frequency reuse is used, the associated base station needs to be able to use different RUs to communicate with different UEs that are in reuse together. The RUs used to implement this type of frequency reuse may need to implement special features that support communicating different sets of control-plane and user-plane messages for each of the UEs in reuse and that support determining which subset of RUs should be used for wirelessly communicating with each UE. Combining receiver and frequency reuse functions supported by multi-RU donor base stations 124 can still be used with the vDAS 100 because the vDAS 100 is able to instantiate multiple, separate virtual RUs, RPs, or RRHs for any such multi-RU donor base station 124 coupled to the vDAS 100 and implement any needed special multi-RU features or functions.

However, providing support for such multi-RU features or functions may increase the resources required to serve the donor base station 124 relative to serving a donor base station 124 using a traditional “single-RU” approach, whereas serving a donor base station 124 using such a traditional single-RU approach (where the donor base station 124 “sees” the vDAS 100 as a single RU, RP, or RRH and the vDAS 100 does not provide any needed special multi-RU features or functions for the donor base station 124) will tend to require less resources relative to using the multi-RU approach.

The optional micro services 516 implemented for the vMU and/or vICN roles can also include donor-base-station coexistence services. Examples of donor-base-station coexistence services include, without limitation, services that interact with each donor base station 124 to enable the vDAS 100 to automatically determine information about the donor base station 124 and the cell being served for use in configuring the vDAS 100 (including, for example, protocol parameters such as bandwidth, MIMO support, numerology, number of carriers, etc.).

The optional micro services 516 implemented for the vMU and/or vICN roles can also include radio access network (RAN)-assisted mode services, such as determining statistics (for example, key performance indicators (KPIs)) for the vDAS 100, which can be done on a DAS-wide level (that is, without per-UE resolution) or can be done on a per-UE level. Determining statistics on a DAS-wide level is less computationally intensive, while doing it on a per-UE level is more computationally intensive. In the case of determining statistics on a per-UE level, the vMU 112 would decode data provided by the donor base stations 124 and use the decoded information to determine KPIs within the vDAS 100. These KPIs (or information derived therefrom) can be used for various purposes. For example, such information can be presented to the operator of the vDAS 100, the operator of one or more donor base stations 124, or otherwise communicated to a management or control entity of the vDAS 100, donor base stations 124, or RAN) (for example, by communicating such data to a DAS management system or to a near real-time RAN intelligent controller (NR RIC) or other RIC entity that is a part of the service, management, and orchestration (SMO) framework). This can be done to enable the operator to adjust operational parameters (or otherwise adjust the configuration) of the donor base stations 124 and/or the vDAS 100 to achieve better performance. These adjustments can be performed on a one-time basis, periodically, or in response to a detected condition. Such adjustments can be performed manually (in which case the key performance indicators can be used by the person making the adjustment) or automatically. In general, this can be done by having the relevant entity in the vDAS 100 (for example, a vMU 112 of the vDAS 100) decode data communicated via the vDAS 100 (such as decoding Downlink Control Information (DCI) communicated via the vDAS 100) to determine UE-level information about the service provided using the vDAS 100 and to make uplink measurements such as signal-to-interference-plus-noise ratio (SINR) measurements on a per-UE-level. These services can be scaled, for example, by disabling them entirely or performing them less often (less frequently) or performing them in a less processor intensive manner.

The optional micro services 516 implemented for the vMU and/or vICN roles can include other services or functions.

The self-configuration entities 502 can be configured to determine the scaled configuration for the vDAS 100 using a look-up table 518 that stores information about various scaled configurations of the vDAS 100 suitable for use with various combinations of characteristics of donor base stations 124 and available resources for the vDAS 100.

Each of the various scaled configurations of the vDAS 100 stored in the look-up table 518 can be defined as sets or groups of “slices” to implement the various roles of the vDAS 100. As used, here a “slice” refers to a grouping of micro services 512 implemented by the scalable software 500 of the vDAS 100 that can be executed together using one or more physical server computers 104 in order to implement some of the processing needed for one or more roles of the vDAS 100. Each slice also specifies a particular configuration for each of the micro services 512 associated with the slice.

The various slices defined for a vDAS 100 can include mandatory slices (which are slices that include only mandatory micro services 514) and optional slices (which are slices that include at least some optional micro services 516). Information about each of the various scaled configurations of the vDAS 100 (and the associated group of slices for that scaled configuration) is stored in the look-up table 518. The information stored in the look-up table 518 for each of the various scaled configurations for the vDAS 100 can also include a respective minimum value for each of the various types of resources used to implement the vDAS 100. The information stored in the look-up table 518 for each of the various scaled configurations for the vDAS 100 can also include information about which donor base stations 124 (having certain characteristics) are appropriate to use with each of the various scaled configurations for the vDAS 100.

The candidate scaled configurations for the vDAS 100 stored in the look-up table 518 should have a wide range of minimum resources needs and/or wide range of suitable donor base stations configurations. That is, some of the scaled configurations for the vDAS 100 stored in the look-up table 518 can have relatively higher minimum resources needs (that is, can be associated with higher amounts of available resources) and some of the scaled configurations for the vDAS 100 stored in the look-up table 518 can have relatively lesser minimum resources needs (that is, can be associated with lesser amounts of available resources). The range of scaled configurations for the vDAS 100 can be determined in an iterative or stepwise manner in which successive services or features are adjusted until a range of minimum resources are provided.

In order to adjust the minimum resources needed for a given scaled configuration for the vDAS 100, one or more of the following can be done. The size and/or number of the simulcast zones supported can be adjusted for some of the scaled configurations for the vDAS 100. The number of antenna carriers used for uplink communications (and/or for downlink communications) can be adjusted for some of the scaled configurations for the vDAS 100. For example, using a 4×4 MIMO will use more resources than a 4×3 MIMO configuration, which will use more resources than a 4×2 MIMO configuration, where each successive configuration reduces the number of uplink antenna carriers that need to be aggregated. As noted above, the aggregation of uplink data can be performed on an antenna-carrier-by-antenna-carrier basis so that it can be scaled as needed. The number of active access points 114 can be adjusted for some of the scaled configurations for the vDAS 100. For example, to reduce the minimum resource requirements for a given scaled configuration, the number of active access points 114 can be reduced and the transmit power of the remaining active access points 114 can be increased in order to improve the coverage provided by the remaining active access points 114. One or more optional micro services 156 or optional slices used in the scaled configuration can be adjusted for some of the scaled configurations for the vDAS 100. For example, to reduce the minimum resource requirements for a given scaled configuration, one or more optional micro services 156 or optional slices can be performed in a less resource intensive manner (for example, by performing them less frequently) or be disabling them entirely (that is, not including the one or more optional micro services 156 or optional slices in the given scaled configuration).

The various scaled configurations for the vDAS 100 (and the minimum resource values for each of the various types of resources used to implement the vDAS 100 and the information about which donor base stations 124 (having certain characteristics) are appropriate to use with the various scaled configurations for the vDAS 100) can be determined, for example, in an offline process.

The look-up table 518 is accessible to the one or more self-configuration entities 502 for use in selecting an appropriate scaled configuration for the vDAS 100. For example, the self-configuration master software 508 can use the look-up table 518 to determine a scaled configuration for the vDAS 100 by selecting, from the various candidate scaled configurations for the vDAS 100 stored in the look-up table 518, one candidate scaled configuration for the vDAS 100 that is the most appropriate to use with (that is, selecting the candidate scaled configuration for the vDAS 100 that is the best “match” for) the determined characteristics of the donor base stations 124 used with the vDAS 100 and the determined available resources for the vDAS 100. A given candidate scaled configuration for the vDAS 100 matches the determined characteristics of the donor base stations 124 and the determined available resources for the vDAS 100 if the set of slices associated with that candidate scaled configuration can be used to properly serve the particular donor base stations 124 using the available resources for the vDAS 100. There may be multiple scaled configurations that match the determined characteristics of the donor base stations 124 and the determined available resources for the vDAS 100. In case there are multiple matching scaled configurations, the information about the various candidate scaled configurations for the vDAS 100 stored in the look-up table 518 can also include priority (or similar) information that can be used to determine which of multiple matching scaled configurations for the vDAS 100 should be used (for example, by selecting the matching scaled configuration having the highest priority).

The self-configuration master software 508 can then cause the management system 510 for the vDAS 100 to configure the vDAS 100 to implement the selected scaled configuration for the vDAS 100. That is, the self-configuration master software 508 can cause the management system 510 to configure the vDAS 100 so that the various physical server computers 104 run the micro services 512 included in the group of slices associated with the selected scaled configuration where each of the micro services 512 is configured as specified in the associated slice.

The look-up table 518 can be continuously or periodically updated with the various types of donor base stations 124 and available resources for implementing the vDAS 100 that may be encountered in the field (for example, this can be done as new types of donor base stations 124, physical server computers 124, and fronthaul networks 120 (and components and features thereof) become available).

The scalable software 500 can be implemented in other ways and/or the scaled configuration for the vDAS 100 can be determined in other ways.

Embodiments of method 600 can be used to automatically configure a vDAS 100 based on the specific characteristics of the donor base stations 124 used with the vDAS 100 and the specific resources that are available for implementing the vDAS 100. This can be done without extensive user intervention, which makes the vDAS 100 easier to deploy in cloud (or other) environments with varying types of available resources. Also, this can be done while still being able to provide resource-intensive optional services and features when doing so is possible.

Other embodiments can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a virtualized distributed antenna system (vDAS) to serve a set of one or more donor base stations, the vDAS comprising: a set of one or more physical server computers on which scalable vDAS software is executed, each of which is configured to execute respective virtualization software that creates a respective virtualized environment in which the scalable vDAS software is executed to carry out a respective one or more roles for the vDAS; a plurality of access points (APs), each of the APs associated with a respective set of coverage antennas and each of the APs communicatively coupled to at least one of the set of physical server computers; and one or more self-configuration entities configured to: determine characteristics of the one or more donor base stations; determine available resources that are available to implement the vDAS; determine, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and configure the vDAS to serve the one or more donor base stations in accordance with the scaled configuration by executing the scalable vDAS software on each of the physical server computers in accordance with the scaled configuration.

Example 2 includes the vDAS of Example 1, wherein the one or more self-configuration entities are configured to determine the characteristics of the one or more donor base stations by doing one or more of the following: communicate with one or more of the donor base stations; and communicate with a management entity associated with the donor base stations.

Example 3 includes the vDAS of any of Examples 1-2, wherein the characteristics of the one or more donor base stations comprise one or more of the following: donor interface types supported by each of the one or more donor base stations; radio unit entity configurations supported by each of the one or more donor base stations; air interface bandwidths supported by each of the one or more donor base stations; duplexing schemes supported by each of the one or more donor base stations; end-to-end latency requirements for each of the one or more donor base stations; antenna ports supported by each of the one or more donor base stations; and numerologies supported by each of the one or more donor base stations.

Example 4 includes the vDAS of any of Examples 1-3, wherein the one or more self-configuration entities comprise: respective self-configuration client software configured to execute on each of the one or more physical servers; and self-configuration master software configured to communicate with the respective self-configuration client software executing on each of the one or more physical servers; and wherein the respective self-configuration client software is configured to determine at least some of the available resources available to implement the vDAS and communicate, to the self-configuration master software, information about said at least some of the available resources available to implement the vDAS.

Example 5 includes the vDAS of any of Examples 1-4, wherein the available resources that are available to implement the vDAS comprise at least one of: resources provided by the set of one or more physical server computers, bandwidth and other characteristics of communication connectivity used for communications between nodes of the vDAS, and bandwidth and other characteristics of communication connectivity used for communications between the set of donor base stations and the vDAS.

Example 6 includes the vDAS of any of Examples 1-5, wherein the available resources that are available to implement the vDAS comprise at least one of: processor cores provided by the set of one or more physical server computers; clock frequency provided by the set of one or more physical server computers; central processor unit (CPU) make, model, or architecture provided by the set of one or more physical server computers; memory provided by the set of one or more physical server computers; Ethernet bandwidth supported by the set of one or more physical server computers; an operating system provided by the set of one or more physical server computers; Peripheral Component Interconnect Express (PCIe) configuration provided by the set of one or more physical server computers; threading/hyperthreading configuration and resources provided by the set of one or more physical server computers; input-output (IO) acceleration provided by the set of one or more physical server computers; socket configuration provided by the set of one or more physical server computers; CPU pinning or isolation provided by the set of one or more physical server computers; and non-uniform memory access (NUMA) awareness provided by the set of one or more physical server computers.

Example 7 includes the vDAS of any of Examples 1-6, wherein the scalable vDAS software comprises, for each of the one or more roles for the vDAS, a respective set of mandatory services and a respective set of optional services.

Example 8 includes the vDAS of any of Examples 1-7, wherein a set of slices are defined for each of the one or more roles for the vDAS, wherein each slice specifies a respective subset of the set of mandatory services and a respective subset of the set of optional services to execute for that slice.

Example 9 includes the vDAS of any of Examples 1-8, wherein the one or more roles for the vDAS comprise at least one of: a virtual master unit (vMU) role and a virtual intermediary combining node (vICN).

Example 10 includes the vDAS of any of Examples 1-9, wherein each of the plurality of APs is communicatively coupled to at least one of the set of physical server computers using a switched Ethernet network.

Example 11 includes the vDAS of any of Examples 1-10, wherein the set of donor base stations comprise one of the following: a radio frequency (RF) interface donor base station coupled to the vDAS using an analog RF fronthaul interface supported by the RF interface donor base station; a Common Public Radio Interface (CPRI) donor base station coupled to the vDAS using a CPRI fronthaul interface supported by the CPRI donor base station; and a Ethernet donor base station coupled to the vDAS using an Ethernet fronthaul interface supported by the Ethernet donor base station.

Example 12 includes the vDAS of Example 11, wherein the Ethernet fronthaul interface comprises at least one of an evolved CPRI (eCPRI) interface, an IEEE 1914.3 Radio-over-Ethernet (RoE) interface, a functional application programming interface (FAPI) interface, a network FAPI (nFAPI) interface), or an Open RAN (O-RAN) fronthaul interface.

Example 13 includes the vDAS of any of Examples 1-12, wherein the vDAS is configured to serve the set of donor base stations by wirelessly transmitting downlink radio frequency (RF) signals for the respective donor base station from the respective set of coverage antenna associated with a respective subset of the APs associated with the respective donor base station and wirelessly receiving uplink RF signals for the respective donor base station from the respective set of coverage antenna associated with the respective subset of the APs associated with the respective donor base station.

Example 14 includes the vDAS of any of Examples 1-13, wherein the one or more self-configuration entities are configured to determine the scaled configuration for the vDAS using a look-up table that includes information about various configurations of the vDAS suitable for use with various combinations of characteristics of donor base stations and available resources for the vDAS.

Example 15 includes a method of configuring a virtualized distributed antenna system (vDAS) used to serve a set of one or more donor base stations, the vDAS comprising a set of one or more physical server computers, each of which is configured to execute respective virtualization software that creates a respective virtualized environment in which the scalable vDAS software is executed to carry out a respective one or more roles for the vDAS, the vDAS further comprising a plurality of access points (APs), each of the APs associated with a respective set of coverage antennas and each of the APs communicatively coupled to at least one of the set of physical server computers, the method comprising: determining characteristics of the one or more donor base stations; determining available resources that are available to implement the vDAS; determining, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and configuring the vDAS to serve the one or more donor base stations in accordance with the scaled configuration by executing the scalable vDAS software on each of the physical server computers in accordance with the scaled configuration.

Example 16 includes the method of Example 15, wherein determining the characteristics of the one or more donor base stations by doing one or more of the following: communicating with one or more of the donor base stations; and communicating with a management entity associated with the donor base stations.

Example 17 includes the method of any of Examples 15-16, wherein the characteristics of the one or more donor base stations comprise one or more of the following: donor interface types supported by each of the one or more donor base stations; radio unit entity configurations supported by each of the one or more donor base stations; air interface bandwidths supported by each of the one or more donor base stations; duplexing schemes supported by each of the one or more donor base stations; end-to-end latency requirements for each of the one or more donor base stations; antenna ports supported by each of the one or more donor base stations; and numerologies supported by each of the one or more donor base stations.

Example 18 includes the method of any of Examples 15-17, wherein determining the characteristics of the one or more donor base stations comprises: executing respective self-configuration client software on each of the one or more physical servers to determine at least some of the available resources available to implement the vDAS; and communicating, to self-configuration master software, information about the at least some of the available resources available to implement the vDAS.

Example 19 includes the method of any of Examples 15-18, wherein the available resources that are available to implement the vDAS comprise at least one of: resources provided by the set of one or more physical server computers, bandwidth and other characteristics of communication connectivity used for communications between nodes of the vDAS, and bandwidth and other characteristics of communication connectivity used for communications between the set of donor base stations and the vDAS.

Example 20 includes the method of any of Examples 15-19, wherein the available resources that are available to implement the vDAS comprise at least one of: processor cores provided by the set of one or more physical server computers; clock frequency provided by the set of one or more physical server computers; central processor unit (CPU) make, model, or architecture provided by the set of one or more physical server computers; memory provided by the set of one or more physical server computers;

Ethernet bandwidth supported by the set of one or more physical server computers; an operating system provided by the set of one or more physical server computers; Peripheral Component Interconnect Express (PCIe) configuration provided by the set of one or more physical server computers; threading/hyperthreading configuration and resources provided by the set of one or more physical server computers; input-output (IO) acceleration provided by the set of one or more physical server computers; socket configuration provided by the set of one or more physical server computers; CPU pinning or isolation provided by the set of one or more physical server computers; and non-uniform memory access (NUMA) awareness provided by the set of one or more physical server computers.

Example 21 includes the method of any of Examples 15-20, wherein the scalable vDAS software comprises, for each of the one or more roles for the vDAS, a respective set of mandatory services and a respective set of optional services.

Example 22 includes the method of any of Examples 15-21, wherein a set of slices are defined for each of the one or more roles for the vDAS, wherein each slice specifies a respective subset of the set of mandatory services and a respective subset of the set of optional services to execute for that slice.

Example 23 includes the method of any of Examples 15-22, wherein the one or more roles for the vDAS comprise at least one of: a virtual master unit (vMU) role and a virtual intermediary combining node (vICN).

Example 24 includes the method of any of Examples 15-23, wherein each of the plurality of APs is communicatively coupled to at least one of the set of physical server computers using a switched Ethernet network.

Example 25 includes the method of any of Examples 15-24, wherein the set of donor base stations comprise one of the following: a radio frequency (RF) interface donor base station coupled to the vDAS using an analog RF fronthaul interface supported by the RF interface donor base station; a Common Public Radio Interface (CPRI) donor base station coupled to the vDAS using a CPRI fronthaul interface supported by the CPRI donor base station; and a Ethernet donor base station coupled to the vDAS using an Ethernet fronthaul interface supported by the Ethernet donor base station.

Example 26 includes the method of Example 25, wherein the Ethernet fronthaul interface comprises at least one of an evolved CPRI (eCPRI) interface, an IEEE 1914.3 Radio-over-Ethernet (RoE) interface, a functional application programming interface (FAPI) interface, a network FAPI (nFAPI) interface), or an Open RAN (O-RAN) fronthaul interface.

Example 27 includes the method of any of Examples 15-26, wherein the vDAS is configured to serve the set of donor base stations by wirelessly transmitting downlink radio frequency (RF) signals for the respective donor base station from the respective set of coverage antenna associated with a respective subset of the APs associated with the respective donor base station and wirelessly receiving uplink RF signals for the respective donor base station from the respective set of coverage antenna associated with the respective subset of the APs associated with the respective donor base station.

Example 28 includes the method of any of Examples 15-27, wherein determining the scaled configuration for the vDAS comprises determining the scaled configuration for the vDAS using a look-up table that includes information about various configurations of the vDAS suitable for use with various combinations of characteristics of donor base stations and available resources for the vDAS.

What is claimed is:

1. A virtualized distributed antenna system (vDAS) to serve a set of one or more donor base stations, the vDAS comprising:
a set of one or more physical server computers on which scalable vDAS software is executed, each of which is configured to execute respective virtualization software that creates a respective virtualized environment in which the scalable vDAS software is executed to carry out a respective one or more roles for the vDAS;
a plurality of access points (APs), each of the APs associated with a respective set of coverage antennas and each of the APs communicatively coupled to at least one of the set of physical server computers; and
one or more self-configuration entities configured to:
determine characteristics of the one or more donor base stations;
determine available resources that are available to implement the vDAS;
determine, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and
configure the vDAS to serve the one or more donor base stations in accordance with the scaled configuration by executing the scalable vDAS software on each of the physical server computers in accordance with the scaled configuration.

2. The vDAS of claim 1, wherein the one or more self-configuration entities are configured to determine the characteristics of the one or more donor base stations by doing one or more of the following:
communicate with one or more of the donor base stations; and
communicate with a management entity associated with the donor base stations.

3. The vDAS of claim 1, wherein the characteristics of the one or more donor base stations comprise one or more of the following:
donor interface types supported by each of the one or more donor base stations;
radio unit entity configurations supported by each of the one or more donor base stations;
air interface bandwidths supported by each of the one or more donor base stations;
duplexing schemes supported by each of the one or more donor base stations;
end-to-end latency requirements for each of the one or more donor base stations;
antenna ports supported by each of the one or more donor base stations; and
numerologies supported by each of the one or more donor base stations.

4. The vDAS of claim 1, wherein the one or more self-configuration entities comprise:
respective self-configuration client software configured to execute on each of the one or more physical servers; and
self-configuration master software configured to communicate with the respective
self-configuration client software executing on each of the one or more physical servers; and
wherein the respective self-configuration client software is configured to determine at least some of the available resources available to implement the vDAS and communicate, to the self-configuration master software, information about said at least some of the available resources available to implement the vDAS.

5. The vDAS of claim 1, wherein the available resources that are available to implement the vDAS comprise at least one of: resources provided by the set of one or more physical server computers, bandwidth and other characteristics of communication connectivity used for communications between nodes of the vDAS, and bandwidth and other characteristics of communication connectivity used for communications between the set of donor base stations and the vDAS.

6. The vDAS of claim 1, wherein the available resources that are available to implement the vDAS comprise at least one of:
processor cores provided by the set of one or more physical server computers;
clock frequency provided by the set of one or more physical server computers;
central processor unit (CPU) make, model, or architecture provided by the set of one or more physical server computers;
memory provided by the set of one or more physical server computers;
Ethernet bandwidth supported by the set of one or more physical server computers;
an operating system provided by the set of one or more physical server computers;
Peripheral Component Interconnect Express (PCIe) configuration provided by the set of one or more physical server computers;
threading/hyperthreading configuration and resources provided by the set of one or more physical server computers;
input-output (IO) acceleration provided by the set of one or more physical server computers;
socket configuration provided by the set of one or more physical server computers;
CPU pinning or isolation provided by the set of one or more physical server computers; and
non-uniform memory access (NUMA) awareness provided by the set of one or more physical server computers.

7. The vDAS of claim 1, wherein the scalable vDAS software comprises, for each of the one or more roles for the vDAS, a respective set of mandatory services and a respective set of optional services.

8. The vDAS of claim 1, wherein a set of slices are defined for each of the one or more roles for the vDAS, wherein each slice specifies a respective subset of the set of mandatory services and a respective subset of the set of optional services to execute for that slice.

9. The vDAS of claim 1, wherein the one or more roles for the vDAS comprise at least one of: a virtual master unit (vMU) role and a virtual intermediary combining node (vICN).

10. The vDAS of claim 1, wherein each of the plurality of APs is communicatively coupled to at least one of the set of physical server computers using a switched Ethernet network.

11. The vDAS of claim 1, wherein the set of donor base stations comprise one of the following:
a radio frequency (RF) interface donor base station coupled to the vDAS using an analog RF fronthaul interface supported by the RF interface donor base station;
a Common Public Radio Interface (CPRI) donor base station coupled to the vDAS using a CPRI fronthaul interface supported by the CPRI donor base station; and
a Ethernet donor base station coupled to the vDAS using an Ethernet fronthaul interface supported by the Ethernet donor base station.

12. The vDAS of claim 11, wherein the Ethernet fronthaul interface comprises at least one of an evolved CPRI (eCPRI) interface, an IEEE 1914.3 Radio-over-Ethernet (RoE) interface, a functional application programming interface (FAPI) interface, a network FAPI (nFAPI) interface), or an Open RAN (O-RAN) fronthaul interface.

13. The vDAS of claim 1, wherein the vDAS is configured to serve the set of donor base stations by wirelessly transmitting downlink radio frequency (RF) signals for the respective donor base station from the respective set of coverage antenna associated with a respective subset of the APs associated with the respective donor base station and wirelessly receiving uplink RF signals for the respective donor base station from the respective set of coverage antenna associated with the respective subset of the APs associated with the respective donor base station.

14. The vDAS of claim 1, wherein the one or more self-configuration entities are configured to determine the scaled configuration for the vDAS using a look-up table that includes information about various configurations of the vDAS suitable for use with various combinations of characteristics of donor base stations and available resources for the vDAS.

15. A method of configuring a virtualized distributed antenna system (vDAS) used to serve a set of one or more donor base stations, the vDAS comprising a set of one or more physical server computers, each of which is configured to execute respective virtualization software that creates a respective virtualized environment in which the scalable vDAS software is executed to carry out a respective one or more roles for the vDAS, the vDAS further comprising a plurality of access points (APs), each of the APs associated with a respective set of coverage antennas and each of the APs communicatively coupled to at least one of the set of physical server computers, the method comprising:
determining characteristics of the one or more donor base stations;
determining available resources that are available to implement the vDAS;
determining, using the characteristics of the one or more donor base stations and the available resources available to implement the vDAS, a scaled configuration for the vDAS to serve the one or more donor base stations that is scaled so that the available resources available to implement the vDAS are sufficient to implement the vDAS in accordance with the scaled configuration; and
configuring the vDAS to serve the one or more donor base stations in accordance with the scaled configuration by executing the scalable vDAS software on each of the physical server computers in accordance with the scaled configuration.

16. The method of claim 15, wherein determining the characteristics of the one or more donor base stations by doing one or more of the following:
communicating with one or more of the donor base stations; and
communicating with a management entity associated with the donor base stations.

17. The method of claim 15, wherein the characteristics of the one or more donor base stations comprise one or more of the following:
donor interface types supported by each of the one or more donor base stations;
radio unit entity configurations supported by each of the one or more donor base stations;
air interface bandwidths supported by each of the one or more donor base stations;
duplexing schemes supported by each of the one or more donor base stations;
end-to-end latency requirements for each of the one or more donor base stations;
antenna ports supported by each of the one or more donor base stations; and
numerologies supported by each of the one or more donor base stations.

18. The method of claim 15, wherein determining the characteristics of the one or more donor base stations comprises:
executing respective self-configuration client software on each of the one or more physical servers to determine at least some of the available resources available to implement the vDAS; and
communicating, to self-configuration master software, information about the at least some of the available resources available to implement the vDAS.

19. The method of claim 15, wherein the available resources that are available to implement the vDAS comprise at least one of: resources provided by the set of one or more physical server computers, bandwidth and other characteristics of communication connectivity used for communications between nodes of the vDAS, and bandwidth and other characteristics of communication connectivity used for communications between the set of donor base stations and the vDAS.

20. The method of claim 15, wherein the available resources that are available to implement the vDAS comprise at least one of:
processor cores provided by the set of one or more physical server computers;
clock frequency provided by the set of one or more physical server computers;
central processor unit (CPU) make, model, or architecture provided by the set of one or more physical server computers;
memory provided by the set of one or more physical server computers;
Ethernet bandwidth supported by the set of one or more physical server computers;
an operating system provided by the set of one or more physical server computers;
Peripheral Component Interconnect Express (PCIe) configuration provided by the set of one or more physical server computers;
threading/hyperthreading configuration and resources provided by the set of one or more physical server computers;
input-output (IO) acceleration provided by the set of one or more physical server computers;
socket configuration provided by the set of one or more physical server computers;
CPU pinning or isolation provided by the set of one or more physical server computers; and
non-uniform memory access (NUMA) awareness provided by the set of one or more physical server computers.

21. The method of claim 15, wherein the scalable vDAS software comprises, for each of the one or more roles for the vDAS, a respective set of mandatory services and a respective set of optional services.

22. The method of claim 15, wherein a set of slices are defined for each of the one or more roles for the vDAS, wherein each slice specifies a respective subset of the set of mandatory services and a respective subset of the set of optional services to execute for that slice.

23. The method of claim 15, wherein the one or more roles for the vDAS comprise at least one of: a virtual master unit (vMU) role and a virtual intermediary combining node (vICN).

24. The method of claim 15, wherein each of the plurality of APs is communicatively coupled to at least one of the set of physical server computers using a switched Ethernet network.

25. The method of claim 15, wherein the set of donor base stations comprise one of the following:
a radio frequency (RF) interface donor base station coupled to the vDAS using an analog RF fronthaul interface supported by the RF interface donor base station;
a Common Public Radio Interface (CPRI) donor base station coupled to the vDAS using a CPRI fronthaul interface supported by the CPRI donor base station; and
a Ethernet donor base station coupled to the vDAS using an Ethernet fronthaul interface supported by the Ethernet donor base station.

26. The method of claim 25, wherein the Ethernet fronthaul interface comprises at least one of an evolved CPRI (eCPRI) interface, an IEEE 1914.3 Radio-over-Ethernet (RoE) interface, a functional application programming interface (FAPI) interface, a network FAPI (nFAPI) interface), or an Open RAN (O-RAN) fronthaul interface.

27. The method of claim 15, wherein the vDAS is configured to serve the set of donor base stations by wirelessly transmitting downlink radio frequency (RF) signals for the respective donor base station from the respective set of coverage antenna associated with a respective subset of the APs associated with the respective donor base station and wirelessly receiving uplink RF signals for the respective donor base station from the respective set of coverage antenna associated with the respective subset of the APs associated with the respective donor base station.

28. The method of claim 15, wherein determining the scaled configuration for the vDAS comprises determining the scaled configuration for the vDAS using a look-up table that includes information about various configurations of the vDAS suitable for use with various combinations of characteristics of donor base stations and available resources for the vDAS.
